(19) United States
(12) Patent Application Publication
(10) Pub. No.: US 2021/0267367 A1
(43) Pub. Date: Sep. 2, 2021

(54) CONVERTIBLE ITEM

(71) Applicant: Ashley Norman Olsson, Darra, QLD (AU)

(72) Inventor: Ashley Norman Olsson, Darra, QLD (AU)

(21) Appl. No.: 17/263,091

(22) PCT Filed: Jul. 25, 2019
(86) PCT No.: PCT/AU2019/050780

§ 371 Date: Jan. 25, 2021

(30) Foreign Application Priority Data
Jul. 25, 2018 (AU) 2018902694
May 28, 2019 (AU) 2019901825

(51) Int. Cl. A47B 85/06; A47B 3/083; A47B 3/08; A47B 43/00; A47B 83/04; A47B 46/00; A47B 5/06

(52) U.S. Cl. CPC A47B 85/06; A47B 3/083; A47B 3/0818; A47B 43/00; A47B 2200/004; A47B 46/005; A47B 5/06; A47B 2200/0001; A47B 83/045

(57) ABSTRACT

A convertible item of furniture (100) comprising: a plurality of shelf units (1), wherein each said shelf unit (1) comprises a substantially horizontally extending leave (10) and a leave support (11) for supporting the leave (10); a linkage system (2) comprising linkage members (21, 22) pivotally connected to each said leave support (11) such that the linkage members (21, 22) are able to pivot in unison and parallel with each other between (i) a shelf configuration whereby the linkage members (21, 22) extend substantially vertically and said leaves (10) extend in spaced substantially horizontal parallel planes above one another, and (ii) a substantially flat surface configuration whereby the linkage members (21, 22) extend substantially horizontally and said leaves (10) are positioned next to one another to form a substantially flat surface having a front end and a rear end; and, at least one surface support (3) for supporting the substantially flat surface.

This application claims priority of Australian provisional application number 2018902694, filed 25 Jul. 2018, and provisional application number 2019901825, filed 28 May 2019, the entire contents of which are incorporated herein by way of cross-reference.

### TECHNICAL FIELD

In some embodiments the present invention relates to a convertible item that in a first configuration provides a substantially horizontal surface and in a second configuration provides a substantially vertically extending set of shelves. In some embodiments the present invention relates to a convertible item of furniture that in a first configuration provides a substantially flat surface such as a table or mattress base, and in a second configuration provides a substantially vertically extending set of shelves.

### BACKGROUND ART

Convertible items of furniture are known. One such furniture item can be converted from a table into shelves. This furniture item has a series of shelves that can be lowered to adopt a table configuration or raised to adopt a shelf configuration. The series of shelves are supported above the ground by a stand/table legs.

A disadvantage of this furniture item is that the stand/table legs must be located midway between the first and last shelves otherwise the table top will tip. Another disadvantage of this furniture item is that a larger number of shelves cannot be used, else the table top will tip when in the table configuration because the stand/table legs are located midway between the first and last shelves. Another disadvantage of this furniture item is that the stand/table legs flank the sides of the table top, hence preventing seating by persons at this midway position. Hence, fewer people are able to be seated at the table at any one time. Another disadvantage is that due to the wide stand/table legs, when in its shelf configuration, the furniture item must be significantly offset from a wall. Another disadvantage is that because the stand/table legs are located midway, this limits the length of the table to about 1.5 m and, combined with the sides of the table not being accessible, means that the table only comfortably seats two people. This is not a practical solution for, say, a dining table. Another disadvantage is that everything on the shelves needs to be cleared to use the table for dining, so essentially the shelf is only practical for storing items that you would want on the table permanently, such as vases, plates and cutlery.

### SUMMARY OF INVENTION

Some embodiments of the present invention relate to a convertible item of furniture that in a first configuration can provide a substantially flat surface such as a table or mattress base, and in a second configuration can provide a set of vertically extending shelves. Some embodiments of the present invention relate to a convertible item of furniture that in a first configuration provides a substantially flat surface such as a table or mattress base, and in a second configuration provides a substantially vertically extending set of shelves. Some embodiments of the present invention relate to a convertible item of furniture that minimises or overcomes a disadvantage referred to above. Some embodiments of the present invention relate to a convertible table and shelves that minimises or overcomes a disadvantage referred to above. Some embodiments of the present invention provide the consumer with a useful convertible item of furniture or commercial choice. Some embodiments of the present invention relate to a convertible item that in a first configuration provides a substantially horizontal surface and in a second configuration provides a substantially vertically extending set of shelves.

According to first embodiment of the present invention there is provided a convertible item of furniture comprising:

a plurality of shelf units, wherein each said shelf unit comprises a substantially horizontally extending leave and a leave support for supporting the leave;

a linkage system comprising linkage members pivotally connected to each said leave support such that the linkage members are able to pivot in unison and parallel with each other between (1) a shelf configuration whereby the linkage members extend substantially vertically and said leaves extend in spaced substantially horizontal parallel planes above one another, and (2) a substantially flat surface configuration whereby the linkage members extend substantially horizontally and said leaves are positioned next to one another to form a substantially flat surface having a front end and a rear end; and

at least one surface support for supporting the substantially flat surface.

The substantially flat surface can be of any suitable size, shape and construction. In some embodiments the substantially flat surface can be in the form of a table, such as a desk, dining table, workbench or gaming table (eg. beer pong table, or ping pong/table tennis table). In the case of a gaming table, indicia (eg. pattern/s or marking/s) appearing on various leaves can produce a larger pattern on the substantially flat surface: eg, a triangular pattern for a beer pong table, or a central line for a table tennis table.

In other embodiments the substantially flat surface can be in the form of a mattress or bed base, for supporting a mattress. In other embodiments, the substantially flat surface can be in the form of a lounge base, for supporting one or more cushions of a lounge. In other embodiments, the substantially flat surface can be in the form of a cushioned surface such as a bed, seat or lounge. The substantially flat surface can be cushioned or lined with cushioning material, such as sponge rubber or latex.

The at least one surface support for supporting the substantially flat surface (in a substantially horizontal disposition) can be of any suitable size, shape and construction, and can be made of any suitable material or materials. For example, the at least one surface support can be made of wood (particleboard, chipboard, MDF, timber), metal and/or plastics material.

In some embodiments the at least one surface support can be in the form of a leg assembly, a stand or a further item of furniture such as a cabinet, cupboard or set of shelves. The at least one surface support can extend from the substantially flat surface to a ground surface or other fixture, such as an interior of a vehicle. That is, the item of furniture can in some embodiments be installed within a vehicle.

In some embodiments the at least one surface support is mountable or fixable to the ground, wall or other fixture. In other embodiments, the at least one surface support is not mountable or fixable to the ground, wall or other fixture, in which case the at least one surface support may or may not be raised and lowered when configuring the item of furniture and may or may not be transportable from one location to another.

In some embodiments, the item of furniture can have a single surface support. In some embodiments, the item of furniture can have two surface supports spaced apart from each other. In some embodiments, the item of furniture can have three, four or more surface supports spaced apart from each other.

In some embodiments the surface support can be connected to the shelf unit and/or to the linkage system. In some embodiments the surface support can be connected to a said shelf unit or to the linkage system such that there is adequate leg room for a person seated at the substantially flat surface (if in the form of a table or desk, for example).

The surface support can be connected to a shelf unit and/or linkage system in any suitable way. For example, one or more mechanical or non-mechanical fasteners can be used to connect an upper part of the surface support or a lower part of the surface support to the shelf unit or linkage system. If connected to a linkage member of the linkage system, then this may be achieved using a connecting pin or other suitable fastener such as a screw or bolt.

The surface support can have a lower part that rests upon the ground/ground surface (eg. floor, concrete slab, earth et cetera).

In some embodiments, the surface support is in the form of a pair of spaced apart substantially vertical legs with an upper part of each leg being connected to a shelf unit or to the linkage system, and a foot extending from a lower part of each vertical leg. The surface support can further comprise reinforcements such as a cross piece extending between the vertical legs and/or a gusset extending between the vertical leg and foot. In some embodiments, the surface support is made of elongate tubular members connected together. In some embodiments an end of the first and/or second linkage members can rest against the foot when in the shelf configuration.

The convertible item of furniture can be movable from one location to another and this can be achieved in any suitable way. In some embodiments, the convertible item of furniture has one or more wheels for moving the convertible item of furniture from one location to another. In some embodiments the surface support comprises one or more wheels or casters for wheeling the convertible item of furniture from one location to another, preferably when in its shelf configuration. Preferably, a caster or wheel or a caster or wheel pair is pinned to each foot of the surface support or to a lower part of the support surface.

The convertible item of furniture can comprise a holding or locking mechanism for holding or locking the convertible item of furniture in the shelf configuration and/or in the substantially flat surface configuration, such that the linkage mechanism cannot allow pivoting from one configuration to the other. Any suitable holding or locking mechanism can be used. In some embodiments this involves a locking pin or latch. In some embodiments the surface support has a locking pin that is retained by a latch mounted to a shelf unit when in the shelf configuration.

The convertible item of furniture can comprise a counterweight for helping a person pivot the shelf units into the shelf configuration. Any suitable type of counterweight can be used. In some embodiments a counterweight is installed on or adjacent a shelf unit at a front of the substantially horizontal support.

The convertible item of furniture can comprise at least one actuator for pivoting, or helping a person pivot in a controlled manner, the shelf units into the shelf configuration or out of the shelf configuration. The actuator can control the pivot motion. The actuator can be controlled by a hand held remote or push button. The actuator can help offset the lift weight and also prevent the shelves from pivoting downwardly too quickly. The actuator can act as a locking mechanism.

Any suitable type of actuator or actuators can be used. In some embodiments the actuator is a gas strut having a first end connected to a surface support and a second end connected to the linkage mechanism or a shelf unit. In some embodiments, the actuator is an electric actuator having a first end connected to a support surface and a second end connected to the linkage mechanism or a shelf unit. In some embodiments the convertible item of furniture comprises two actuators. In some embodiments a pair of actuators is connected either to the primary linkage member pair or to the secondary linkage member pair.

Each shelf unit can be of any suitable size, shape and construction, and can be made of any suitable material or materials. For example, each shelf unit can be made of wood (particleboard, chipboard, MDF, timber), bamboo, composites, alloy, metal and/or plastics material.

Each shelf unit can be of similar construction or of differing construction. Each shelf unit can be of similar appearance or of differing appearance. Each shelf unit can be of any suitable length, width, height and thickness.

In some embodiments a, or each, shelf unit simply provides a leave for supporting one or more articles or items. In some embodiments a, or each, shelf unit is in the form of a cupboard, cabinet, drawer or other closable compartment.

Each shelf unit comprises a substantially horizontally extending leave. Each leave remains substantially perfectly horizontal in any configuration, including when being transitioned between the substantially flat surface configuration and shelf configurations. This is so that any article or item placed on any of the leaves does not fall off.

Preferably, the leave is longer than it is wide. That is, preferably the leave is elongate, having opposed longitudinal ends and opposed ends. Each leave can comprise a top surface, a bottom surface, oppose longitudinal ends, and opposed ends. Each leave can be in the form of a panel or board, such as a wooden panel or board. If desired, the leave can be laminated.

In some embodiments, the leave can have one or more slots or slits for providing clearance for one or more linkage members of the linkage system when pivoting between the substantially flat surface (eg. table) and shelf configurations.

In some embodiments the leave can be discontinuous, being in separate pieces or sections. For example, the leave can comprise two, three, four, five, six or more spaced apart panels/panel sections.

The leave support for supporting the leave can be of any suitable size, shape and construction, and can be made of any suitable material or materials. For example, each leave support can be made of wood (particleboard, chipboard, MDF, timber), bamboo, composites, alloy, metal and/or plastics material. The leave support can in some embodiments be in the form of a shelf bracket or gusset.

In some embodiments the leave support can comprise one or more side walls extending downwardly from the leave (much like shelf brackets or gussets), preferably vertically relative to the leave and preferably parallel with the linkage members. In some embodiments the leave support can comprise spaced side walls extending downwardly from the leave, preferably vertically relative to the leave and preferably parallel with the linkage members. In some embodiments the leave support can comprise one, two, three, four, five, six or even more side walls extending downwardly from the leave. Each side wall can be of integral construction with the leave or connectable to the leave. Each side wall can be in the form of a panel or board fastened to the leave by way of mechanical or non-mechanical fasteners, e.g. screws, nails, adhesive et cetera.

In embodiments where the leave is discontinuous, being in separate pieces or sections, one or more side walls may extend downwardly from each leave piece or section and preferably parallel with the linkage members.

In some embodiments the leave support can comprise one or more rear walls extending downwardly from the leave and/or between adjacent side walls of the leave support. Preferably the rear wall extends vertically from the leave or vertically relative to the leave. In some embodiments a rear wall can extend from the leave to a side wall of the leave support. In some embodiments a rear wall can extend between the leave and each side wall of the leave support. The rear wall can be of integral construction with the leave and/or side walls or connectable to the leave and/or side wall/s. The rear wall can be in the form of a panel or board fastened to the leave and one or more side walls by way of mechanical or non-mechanical fasteners, e.g. screws, nails, adhesive et cetera.

In embodiments where the leave is discontinuous, being in separate pieces or sections, a rear wall may extend downwardly from each leave section or piece and optionally to a side wall.

In some embodiments, the rear wall can be shaped such that there is room for a person's knees beneath the substantially flat surface (e.g. table top) when seated at the substantially flat surface (e.g. table top). In some embodiments the rear wall can be tapered, arched or arcuate as it extends towards a periphery of the substantially flat surface (e.g. table top).

In some embodiments, the rear wall can have one or more slots or slits for providing clearance for one or more linkage members of the linkage system when pivoting between the different configurations.

In some embodiments, one or more leave supports can comprise a drop-down lip or flap that can hide a gap or gaps between the leaves when in the shelf configuration. In some embodiments, a lip can extend upwardly to prevent items inside one or more of the shelves from falling out.

The convertible item of furniture can have any suitable number of shelf units. For example, the convertible item of furniture can have two, three, four, five, six, seven, eight, nine, 10, 11, 12 or even more shelf units. The number of shelf units will depend on factors such as the dimensions of the room in which the convertible item of furniture is to be located. For example, for rooms with standard ceiling heights, the convertible item of furniture (e.g. table and shelves) can have, for example, five, six, seven, eight, nine or 10 shelf units. Preferably the convertible item of furniture (e.g. table and shelves) has six, seven or eight shelf units. More preferably, the convertible item of furniture (e.g. table and shelves) has seven shelf units. If located within a vehicle, the convertible item of furniture can have, for example, three or four shelf units. If located within a vehicle, the support surface can itself be in the form of a cabinet, cupboard, set of drawers or other closable compartment.

One or more of the shelf units can have a secondary shelf located beneath the substantially horizontally extending leave (‘the main leave’). The secondary shelf can be dimensioned so as to be hidden beneath the substantially flat surface (e.g. table top) formed by the main leaves when in the substantially flat surface configuration, and the secondary shelf can be dimensioned so as to serve as a secondary accessible shelf when in the shelf configuration.

The secondary shelf can be of any suitable size, shape and construction, and can be made of any suitable material or materials. Each secondary shelf can be of any suitable length, width and height. Ideally, each secondary shelf will be made of the same material or materials as the shelf unit. Ideally, each secondary shelf will complement/match in with the overall look or appearance of the shelf unit.

The secondary shelf preferably has a substantially horizontally extending secondary leave. Preferably, the secondary leave is spaced beneath its main leave so as to accommodate one or more articles or items. Preferably, the secondary leave is longer than it is wide. That is, preferably the secondary leave is elongate having opposed longitudinal ends and opposed ends. Each secondary leave can comprise a top surface, a bottom surface, oppose longitudinal ends, and opposed ends. Each secondary leave can be in the form of a panel or board, such as a wooden panel or board.

The secondary shelf can have a secondary leave support for supporting the secondary leave. The secondary leave support can be of any suitable size, shape and construction, and can be made of any suitable material or materials. For example, each secondary leave support can be made of wood (particleboard, chipboard, MDF, timber), bamboo, composites, alloys, metal and/or plastics material. The secondary leave support can in some embodiments be in the form of a shelf bracket or gusset.

In some embodiments the secondary leave support can comprise one or more side walls extending upwardly from the secondary leave (much like shelf brackets or gussets), preferably vertically relative to the secondary leave and preferably parallel with the linkage members (although this need not be the case). In some embodiments the side wall can extend from the secondary leave to the main leave. In some embodiments the secondary leave support can comprise spaced side walls extending upwardly from the secondary leave, preferably vertically relative to the leave and preferably parallel with the linkage members (although this need not be the case). In some embodiments the secondary leave support can comprise one, two, three, four, five, six or even more side walls extending from the secondary leave. Each side wall can be of integral construction with the secondary leave or connectable to the secondary leave. Each side wall can be of integral construction with the main leave or connectable to the main leave. Each side wall can be in the form of a panel or board fastened to the secondary leave by way of mechanical or non-mechanical fasteners, e.g. screws, nails, adhesive et cetera.

In some embodiments the secondary leave support can comprise one or more rear walls extending upwardly from the secondary leave and/or between adjacent side walls of the secondary leave support and/or to the main leave. Preferably the rear wall extends vertically from the secondary leave or vertically relative to the secondary leave. In some embodiments a rear wall can extend upwardly from the secondary leave. In some embodiments a rear wall can extend upwardly from the secondary leave to the main leave. In some embodiments a rear wall can extend from the secondary leave to a side wall of the secondary leave support. In some embodiments a rear wall can extend between the secondary leave and each side wall of the secondary leave support. In some embodiments a rear wall can extend between the secondary leave and main leave, and each side wall of the secondary leave support. The rear wall can be of integral construction with the secondary leave and/or main leave and/or side wall/s or connectable to a leave/s and/or side wall/s. The rear wall can be in the form of a panel or board fastened to the secondary and/or main leave and one or more side walls by way of mechanical or non-mechanical fasteners, e.g. screws, nails, adhesive et cetera.

In some embodiments the leave support and secondary leave support or components thereof are one and the same. In some embodiments one or more side walls of the leave support and one or more side walls of the secondary leave support are one and the same. In some embodiments the rear wall of the leave support and the rear wall of the secondary leave support are one and the same.

In some embodiments, the rear wall of the secondary leave support can be shaped such that there is room for a person's knees beneath the substantially flat surface (e.g. table top) when seated at the substantially flat surface (e.g. table top). In some embodiments the rear wall can be tapered, arched or arcuate as it extends towards a periphery of the substantially flat surface (e.g. table top).

As mentioned above, in some embodiments a, or each, shelf unit can comprise one or more doors or slidable drawers for forming a cabinet, cupboard, set of drawers or other closable compartment. In some embodiments a, or each, secondary shelf unit can comprise one or more doors for forming a cabinet, cupboard or other closable compartment. The one or more doors can be hinged or slidable for movement between open and closed positions. The one or more doors can be hinged or slidable for movement relative to a leave or leave support. The one or more doors, hinged or slidable member can be capable of being locked or secured, so as to create a secure compartment, such lockable compartments can be useful when for example the item of furniture is used in a vehicle. In some embodiments a, or each, secondary shelf unit can comprise one or more slidable drawers for forming a set of drawers, with said set of drawers being capable of being locked to create a secure compartment.

In some embodiments a, or each, shelf or secondary shelf unit can comprise a hanging rail or rod, or rope, wire or elastic retainer extending between the side walls.

Any suitable type of linkage system can be used. In some embodiments, the linkage system is in the form of a ‘drive system’ or ‘drive’, as described herein (context permitting).

The linkage system can comprise mechanical fasteners such as fastening pins or pivot pins (eg. screws, bolts, other pin types) for fastening the linkage members to the leave supports or secondary leave supports and about which the linkage members can pivot. Alternatively, mechanical fasteners can be welded, or otherwise of integral construction with, the linkage members.

The leave supports or secondary leave supports can have a linkage-mounting region for receiving or supporting a fastening pin or pivot pin. One or more of the side walls of each leave support or secondary leave support can receive a pivot pin/fastening pin of the linkage system that also holds the linkage member fast. One or more of the side walls can have a projection, lobe, finger or other type of linkage-mounting region for receiving or supporting a fastening pin or pivot pin.

Any suitable number of linkage members can be used. That is, any suitable number of linkage members can be pivotally connected to the shelf units. Each linkage member can be of any suitable size, shape and construction, and can be made of any suitable material or materials. The linkage member can be made of metal, wood, composites or plastics material, for example. In some embodiments, the linkage members can each be a metal bar having openings for receiving the pivot pins/fastening pins. The linkage members can each be a linear/straight metal bar having openings for receiving the pivot pins/fastening pins. In some embodiments, the linkage members can each be a tube or otherwise of tubular construction having openings for receiving the pivot pins/fastening pins. In some embodiments, the linkage members can each be a metal bar having one or more pivot or fastening pins protruding from the metal bar. (In this way a head of the pin cannot be seen.) The linkage members can each be a linear/straight metal bar having protruding pivot pins/fastening pins. In some embodiments, the linkage members can each be a tube or otherwise of tubular construction having one or more pivot or fastening pins protruding from the tube. The first and second primary linkage members can each be a linear/straight tube or otherwise of linear/straight tubular construction having openings for receiving the pivot pins/fastening pins. For example, the linkage members can each be an elongate linear tube of substantially rectangular cross-section having openings for receiving the pivot pins/fastening pins. The linkage members can each extend from a shelf unit at or near to the front of the substantially flat surface (e.g. table top) to a shelf unit located at or near to the rear end of the substantially flat surface (e.g. table top).

The linkage members can comprise a primary linkage member pair and a secondary linkage member pair. The primary linkage member pair can comprise first and second primary linkage members pivotally connected to a respective side wall of each shelf unit. The secondary linkage member pair can be spaced from the primary linkage member pair and can comprise first and second secondary linkage members pivotally connected to a respective side wall of each shelf unit such that the primary and secondary linkage member pairs are able to pivot in unison and parallel with each other.

In some embodiments, the secondary linkage member pair can form part of a table frame that extends as a rectangular frame around a periphery of the table top.

In some embodiments, where the item of furniture is configurable as a table, the item of furniture can comprise a table leg assembly connected to one said shelf unit or to the linkage system. In some embodiments, the table leg assembly can be located approximately midway between the front and rear ends of the substantially flat surface/table top. In some embodiments, the table leg assembly can be located at or near to a front end or at or near to a rear end of the substantially flat surface/table top. The table leg assembly can be mountable or fixable to a ground surface or fixture, or not.

In some embodiments where the item of furniture is configurable as a table, the item of furniture can comprise two table leg assemblies. A front table leg assembly can be connected to one said shelf unit or to the linkage system at or near to the front end of the table top, and a rear table leg assembly can be connected to another said shelf unit or to the linkage system at or near to the rear end of the table top. The table leg assemblies can be mountable or fixable to a ground surface or fixture, or not. In some embodiments, there can be leg room for a person seated at the table top adjacent a first said shelf unit. In some embodiments, there can be leg room for a person seated at the table top adjacent a second said shelf unit.

The front table leg assembly can be of any suitable size, shape and construction, and can be made of any suitable material or materials. The front table leg assembly can be connected to a shelf unit and/or linkage system at or near to the front end of the table top in any suitable way. For example, one or more mechanical or non-mechanical fasteners can be used to connect an upper part of the front table leg assembly to the shelf unit or linkage system. If connected to a linkage member, then this may be achieved using a connecting pin or screw.

The front table leg assembly can have a lower part that rests upon the ground/ground surface (eg. floor, concrete slab, earth et cetera).

In some embodiments, the front table leg assembly is in the form of a pair of spaced apart substantially vertical legs with an upper part of each leg being connected to a shelf unit or to the linkage system, and a foot extending from a lower part of each vertical leg. The front table leg assembly can further comprise reinforcements such as a cross piece extending between the vertical legs and/or a gusset extending between the vertical leg and foot. In preferred embodiments, the front table leg assembly is made of elongate tubular members connected together. In some embodiments an end of the first and/or second linkage members can rest against the foot when in the shelf configuration. In other embodiments the front table leg assembly is secondarily connected to the frame via a gas strut or other suitable load supporting device with said device able to also act or not act as a speed restricting device to prevent the item of furniture from travelling too quickly or in an uncontrolled fashion from an upward vertical stacked/shelf configuration to a substantially flat table configuration.

The convertible table and shelves can be movable from one location to another and this can be achieved in any suitable way. In some embodiments, the convertible table and shelves has one or more wheels for moving the convertible table and shelves from one location to another. In some embodiments the front table leg assembly comprises one or more wheels or casters for wheeling the convertible table and shelves from one location to another, preferably when in its shelf configuration. Preferably, a caster or wheel or a caster or wheel pair is pinned to each foot of the front table leg assembly.

The rear table leg assembly can be of any suitable size, shape and construction, and can be made of any suitable material or materials. The rear table leg assembly can be connected to a shelf unit and/or the linkage system at or near to the rear end of the table top in any suitable way. For example, one or more mechanical or non-mechanical fasteners can be used to connect an upper part of the rear table leg assembly to the shelf unit and/or linkage system. If connected to the linkage system, then this may be achieved using a connecting pin or screw.

The rear table leg assembly can have a lower part that rests upon the ground/ground surface (eg. floor, concrete slab, earth et cetera), but only when in the table configuration.

In some embodiments, the rear table leg assembly is in the form of a pair of spaced apart substantially vertical legs with an upper part of each leg being connected to a shelf unit and/or linkage system. The rear table leg assembly can further comprise reinforcements such as a cross piece extending between the vertical legs. When in the shelf configuration, the rear table leg assembly need not rest against the ground surface. In preferred embodiments, the rear table leg assembly is made of elongate tubular members connected together.

The convertible table and shelves can comprise a holding or locking mechanism for holding or locking the convertible table and shelves in the shelf configuration and/or in the table configuration, such that the linkage mechanism cannot allow pivoting from one configuration to the other. Any suitable holding or locking mechanism can be used. In some embodiments this involves a locking pin or latch. In some embodiments the rear table leg assembly has a locking pin that is retained by a latch mounted to a shelf unit when in the shelf configuration. The locking mechanism can be an actuator as described above.

The convertible table and shelves can comprise a counterweight for helping a person pivot the shelf units into the shelf configuration. Any suitable type of counterweight can be used. In some embodiments a counterweight is installed on or adjacent a shelf unit at a front of the table top.

According to a second embodiment of the invention, there is provided a convertible table and shelves comprising:

a plurality of shelf units, wherein each said shelf unit comprises a substantially horizontally extending leave and a leave support for supporting the leave;

a linkage system comprising linkage members pivotally connected to each said leave support such that the linkage members are able to pivot in unison and parallel with each other between (1) a shelf configuration whereby the linkage members extend substantially vertically and said leaves extend in spaced substantially horizontal parallel planes above one another, and (2) a table configuration whereby the linkage members extend substantially horizontally and said leaves are positioned next to one another in substantially the one and the same substantially horizontal place to form a table top having a front end and a rear end;

a front table leg assembly connected to one said shelf unit or to the linkage system at or near to the front end of the table top such that there is leg room for a person seated at the table top adjacent the first said shelf unit; and

a rear table leg assembly connected to another said shelf unit or to the linkage system at or near to the rear end of the table top such that there is leg room for a person seated at the table top adjacent the second said shelf unit.

According to a third embodiment of the invention, there is provided a convertible table and shelves comprising:

a plurality of shelf units, wherein each said shelf unit comprises a substantially horizontally extending leave and a leave support for supporting the leave;

a linkage system comprising linkage members pivotally connected to each said leave support such that the linkage members are able to pivot in unison and parallel with each other between (1) a shelf configuration whereby the linkage members extend substantially vertically and said leaves extend in spaced substantially horizontal parallel planes above one another, and (2) a table configuration whereby the linkage members extend substantially horizontally and said leaves are positioned next to one another in substantially the one and the same substantially horizontal place to form a table top having a front end and a rear end;

a front table leg assembly connected to one said shelf unit or to the linkage system at or near to the front end of the table top; and

a rear table leg assembly connected to another said shelf unit or to the linkage system at or near to the rear end of the table top.

According to fourth embodiment of the present invention, there is provided a convertible item (such as an item of furniture) comprising:

a plurality of shelf units, wherein each said shelf unit comprises a substantially horizontally extending leave and at least one leave support for supporting the leave;

a linkage system (or drive system) connected to each said leave support such that the leaves are able to pivot in unison and parallel with each other between (1) a shelf configuration whereby the leaves extend in spaced substantially horizontal parallel planes above one another, and (2) a substantially horizontal surface configuration whereby the leaves are positioned next to one another to form a substantially horizontal surface; and

at least one surface support for supporting the shelf units and linkage system.

According to a fifth embodiment of the present invention, there is provided a convertible item (such as an item of furniture) comprising:

a plurality of shelf units, wherein each said shelf unit comprises a substantially horizontally extending leave and at least one leave support for supporting the leave;

a linkage system (or drive system) connected to each said leave support such that the leaves remain substantially horizontal when the shelf units are moved between (1) a shelf configuration whereby the leaves extend in spaced substantially horizontal parallel planes above one another, and (2) a substantially horizontal surface configuration whereby the leaves are positioned next to one another to form a substantially horizontal surface; and

at least one surface support for supporting the shelf units and linkage system.

The following features relate to the fourth and fifth embodiments. However, context permitting, they could equally apply to the earlier embodiments. Also, context permitting, the features described for the first to third embodiments could equally apply to the fourth and fifth embodiments.

The at least one leave support for supporting the leave can be of any suitable size, shape and construction, and can be made of any suitable material or materials. For example, each leave support can be made of bamboo, wood (particleboard, chipboard, MDF, timber), laminated timbers, laminates, metal and/or plastics material. The leave support can in some embodiments be in the form of a shelf bracket or gusset.

In some embodiments, each leave support can be connected or connectable to a rotatable shaft of the linkage system or drive system. In some embodiments, each leave support can have an opening for receiving a respective rotatable shaft of the linkage system or drive system. In some embodiments, the leave support is in the form of a casting, such as a triangular casting fastened to the leave and having an opening for receiving a shaft of the linkage system or drive system. The casting can be made of metal. In alternate embodiments the leave support may be any suitable shape and in the form of a moulded, printed, fabricated, cut-out or extruded part and may be made out of any suitable material including polycarbonates, plastics, alloys, aluminium, carbon fibre, wood or cellulose.

In some embodiments, the linkage system or drive system comprises a respective shaft connected or connectable to each leave support. Each shaft can have a leave support connecting end. Each shaft can have a working region. The working region can be of integral construction with a remainder of the shaft, or the working region can be a separate piece detachably connected to the remainder of the shaft. The shaft may be solid or hollow. Where it is hollow it may accommodate or provide accommodation for wires, tubes or other accessories to be passed through the hollow shaft from the working region end of the shaft to the leave support connecting end to provide a convenient and discrete route for power or light or water to be supplied to each independent leave. The working region can be detachably connected to the remainder of the shaft in any suitable way. The leave support connecting end of the shaft can be connected to the leave support by way of a screwed or threaded connection, key and keyway arrangement, or a splined arrangement, for example. The working region of the shaft can be connected to the remainder of the shaft by way of a screwed connection, key and keyway arrangement, glued, or a splined arrangement, for example. In other embodiments the leave support end, shaft (said shaft can be hollow or solid/not hollow) and connecting end is one integral part capable of connecting or being connectable to the linkage system or drive system. The leave support integral working part complete with solid or hollow shaft with a connecting or connectable working end can be of a unitary construction and made of any suitable material and produced by either singular or multiple processes including casting, moulding, forming, machining, printing or stamping.

In another embodiment the leave support is one piece that extends along the entire length of the leave and is connected to the leave at both ends of the leave. Such leave support member may be connected or connectable at least one end to a linkage system or drive system.

In some embodiments, the linkage system or drive system can comprise at least one mounting frame. The mounting frame can be of any suitable size, shape and construction, and can be made of any suitable material or materials. The mounting frame can comprise one or more frame members. A frame member can extend alongside the leave supports. A respective frame member can extend alongside each side of the shelves, such that the leave supports situated on a first end of the shelves can be connected to a first frame member, and the leave supports situated on a second end of the shelves can be connected to a second frame member. The mounting frame can comprise one or more cross pieces connecting the first frame member to the second frame member.

In some embodiments, the linkage system or drive system comprises at least one mounting frame or mounting frame member extending alongside the leave supports, and said shafts can extend through a wall of the mounting frame such that the working regions and leave supports are located at opposite sides of the wall.

In some embodiments, the linkage system or drive system comprises at least one mounting frame or mounting frame member extending between adjacently situated spaced apart leave supports, and said shafts can extend through the mounting frame or mounting frame member such that the working regions and leave supports are located at opposite sides of the mounting frame or mounting frame member walls.

The mounting frame or frame member can be of hollow or tubular construction. The working region of the shaft can be located within the hollow interior. The mounting frame or frame member can comprise a beam that has a C- or U-shaped cross section/channel, and the working region of the shaft can be located within the channel. The beam can also be any suitable shaped hollow channel, eg. circle, rectangle or triangle, which has enough room for components of the linkage system or drive system to be installed inside the hollow.

In some embodiments, the linkage system or drive system comprises at least one drive connected to the working regions of the shafts, such that the shafts can be rotated in unison. The drive can be of any suitable construction.

In some embodiments, the drive comprises at least one rigid linkage member connected to the working region/s of the shafts by way of pivot pins/fastening pins. The rigid linkage member can be in the form of a bar or tube or other load carrying/transferring member. Preferably, the rigid linking member is linear. In some embodiments, the working region is in the form of a flange and the rigid linkage member is pinned to the flange by way of a pivot pin/fastening pin, bolt, sleeve, stepped shoulder fastener, rivet or other suitable fastener.

In some embodiments, the drive comprises a first rigid linkage member connected to the working regions of the shafts at a first end of the shelves by way of pivot pins/fastener/rivets/pins. In some embodiments, the drive comprises a second rigid linkage member connected to the working regions of the shafts at a second end of the shelves by way of pivot pins/fastener/rivets/pins.

In some embodiments, the drive comprises a primary rigid linkage member pair and a secondary rigid linkage member pair. The primary linkage member pair can comprise first and second primary linkage members connected to the working regions of the shafts at the first and second ends of the shelves by way of pivot pins/fastening pins. The secondary linkage member pair can comprise first and second secondary linkage members connected to the working regions of the shafts at the first and second ends of the shelves by way of pivot pins/fastening pins, and the secondary linkage member pair can be spaced from the primary linkage member pair such that the primary and secondary linkage member pairs are able to pivot in unison and parallel with each other when the leaves are pivoted between the shelf configuration and substantially horizontal surface configuration.

If the drive comprises two rigid linkage members and these are connected to a said working region, then these can be pinned to the flange at opposing sides or ends of the flange.

In some embodiments, the drive comprises at least one worm gear which engages the working regions of the shafts. In some embodiments, the working region is in the form of a spur gear that meshes with the worm gear. As the worm gear turns, so do the shafts in unison.

In some embodiments, the drive comprises a first worm gear connected to the working regions of the shafts at a first end of the shelves. In some embodiments, the drive comprises a second worm gear connected to the working regions of the shafts at a second end of the shelves.

In some embodiments, the drive comprises at least one bevel gear which engages the working regions of the shafts. In some embodiments, the working region is in the form of a spur gear that meshes with the bevel gear. As the bevel gear turns, so do the shafts in unison.

In some embodiments, the drive comprises a first bevel gear connected to the working regions of the shafts at a first end of the shelves. In some embodiments, the drive comprises a second bevel gear connected to the working regions of the shafts at a second end of the shelves.

In some embodiments, the drive comprises at least one pair of racks that engage the working regions of the shafts. In some embodiments, the working region is in the form of a pinion that meshes with and between the racks. As the shaft/pinion turns, the racks slide back and forth within the mounting frame or frame member.

In some embodiments, the drive comprises a first pair of racks connected to the working regions of the shafts at a first end of the shelves. In some embodiments, the drive comprises a second pair of racks connected to the working regions of the shafts at a second end of the shelves.

In some embodiments, the drive comprises a plurality of motors, each of which engages a working region of a shaft. Each of the motors can be electrically connected so that all motors turn the shafts in a synchronised manner, both clockwise and counter clockwise.

In some embodiments, the drive comprises a gear train, allowing the motor to be geared down.

In some embodiments, the drive comprises encoders or other electronic means for monitoring and controlling the speed and degree of rotation of the motors.

In some embodiments, the drive comprises a first plurality of motors connected to the working regions of the shafts at a first end of the shelves. In some embodiments, the drive comprises a second plurality of motors connected to the working regions of the shafts at a second end of the shelves.

In some embodiments, the drive comprises at least one chain or belt drive that engages the working regions of the shafts. In some embodiments, the working region is in the form of a sprocket that meshes with the chain or belt drive. In some embodiments the drive can comprise tensioners located between the sprockets. In some embodiments there can be multiple belts or chains between sprockets.

In some embodiments, the drive comprises a first chain or belt drive connected to the working regions of the shafts at a first end of the shelves. In some embodiments, the drive comprises a second chain or belt drive connected to the working regions of the shafts at a second end of the shelves.

The drive can further comprise at least one handle, crank or motor for rotating the shafts in unison. The at least one handle, crank or motor can be operably connected (directly or indirectly) to a shaft, spur gear, worm gear, bevel gear, chain or belt drive, pinion or racks (as the case may be), so as to rotate the shafts in unison. In some embodiments the angle at which a leave extends can be adjustable independently of the other leaves. That is, the shaft that is connected to the leave support can be further pivoted/rotated as required despite engaging the drive. In some embodiments, a locking gear mechanism utilising meshed gears and a pivoting latch that lockingly engages the gears can be used. In some embodiments, a spring-loaded pivot can be used. In some embodiments, a thread lock can be used for fine adjustment of the leave angle.

In some embodiments the shaft that is connected or connectable to each leave support can further be rotated independently of the other connected or connectable drive working end of the mechanisms by way of an independent drive ring that is situated between the frame or housing member and the working end of the shaft such that the leave support shaft is undependably rotatable around the shaft axis via a friction ring and gear mechanism.

In some embodiments, the shaft that is connected or connectable to each leave support can further extend from the working region completely through the frame member and that end of the shaft can engage the handle, crank or motor.

The substantially horizontal surface can be of any suitable size, shape and construction. In some embodiments the substantially horizontal surface can be in the form of a table, such as a desk, dining table, workbench or gaming table. In some embodiments the shelf units can be in the form of trays and the substantially horizontal surface can be in the form of a fodder table having a substantially horizontal surface formed by a number of adjacent trays for growing fodder in a vertically stacked manner once the table is transitioned to a vertically stacked configuration. In other embodiments the shelf units can contain a singular holder or multiple holders for small pots or receptacles that might be used for vertical growing systems, or for the production of florae, vegetables, herbs or other organisms that may or may not be intended to be harvested.

In other embodiments the substantially horizontal surface can be in the form of a mattress or bed base, for supporting a mattress or mattress segments capable of being situated on the upper surface of each independent leave. In other embodiments, the substantially horizontal surface can be in the form of a lounge base, for supporting one or more cushions of a lounge. In other embodiments, the substantially horizontal surface can be in the form of a cushioned surface such as a bed, seat or lounge. The substantially horizontal surface can be cushioned or lined with cushioning material fashioned to fit each leave, such as sponge rubber or latex.

The at least one surface support for supporting the shelf units and linkage system or drive system can be of any suitable size, shape and construction, and can be made of any suitable material or materials. For example, the at least one surface support can be made of bamboo, wood (particleboard, chipboard, MDF, timber), composites, laminates, any printable material, metal and/or plastics material.

In some embodiments the at least one surface support can be in the form of a leg assembly, a stand or a further item such as furniture, a cabinet, cupboard or set of shelves. The at least one surface support can extend from the substantially horizontal surface to a ground surface or other fixture, such as an interior of a vehicle. That is, the item can in some embodiments be installed within a vehicle. In other embodiments the at least one support surface is substantially vertical, such as a wall in a house or garage or other substantially vertical plane being part of a structure capable of supporting the load exerted by the item, and where the item is suitably affixed or mounted to the substantially vertical support.

In some embodiments the at least one surface support is mountable or fixable to the ground or wall or other fixture. In other embodiments, the at least one surface support is not mountable or fixable to the ground or other fixture, in which case the at least one surface support may or may not be raised and lowered when configuring the item from a substantially horizontal configuration to a substantially vertical stacked configuration and may or may not be transportable from one location to another.

In some embodiments, the item can have a single surface support. In some embodiments, the item can have two surface supports spaced apart from each other. In some embodiments, the item can have three, four or more surface supports spaced apart from each other.

In some embodiments the surface support can be connected to the shelf unit and/or to the linkage system or drive system. In some embodiments the surface support can be connected to a said shelf unit or to the linkage system or drive system such that there is adequate leg room for a person seated at the substantially horizontal surface (if in the form of a table or desk, for example).

The surface support can be connected to a shelf unit(s) and/or linkage system or drive system in any suitable way. For example, one or more mechanical or non-mechanical fasteners can be used to connect a part or parts of the surface support to one or more components of the shelf unit (eg. leave, secondary leave, leave support etc) or one or more component of the linkage system or drive system (eg. mounting frame, frame member, shaft, drive etc). For example, a shaft of the linkage system or drive system can be used to connect a part of the surface support to another component of the linkage system or drive system (eg. frame member), shelf unit and/or leave support.

The surface support can have a lower part that rests upon the ground/ground surface (eg. floor, concrete slab, earth et cetera).

In some embodiments, the surface support is in the form of a pair of spaced apart substantially vertical legs with an upper part of each leg being connected to a shelf unit or to the linkage system or drive system, and a foot extending from a lower part of each vertical leg. The surface support can further comprise reinforcements such as a cross piece extending between the vertical legs and/or a gusset extending between the vertical leg and foot. In some embodiments, the surface support is made of elongate tubular members connected together.

The convertible item can be movable from one location to another and this can be achieved in any suitable way. In some embodiments, the convertible item has one or more wheels for moving the convertible item from one location to another. In some embodiments the surface support comprises one or more rollers, wheels or casters for wheeling the convertible item from one location to another, preferably when in its shelf configuration. Preferably, a caster or wheel or a caster or wheel pair is pinned to each foot of the surface support or to a lower part of the support surface. The unit when mobile can also be capable of self-propulsion and self-navigation by way of any suitable driving mechanism and location system. In some embodiments the wheels can be retractable. For example, the wheels can be on hinges and a lever with an overcentre locking mechanism can be used to extend and retract the wheels.

The convertible item can comprise a holding or locking mechanism for holding or locking the convertible item in the shelf configuration and/or in the substantially horizontal surface configuration, such that the linkage system or drive system cannot allow pivoting from one configuration to the other. Any suitable holding or locking mechanism can be used. In some embodiments this involves a keeper, magnet, electro magnet, locking pin or latch. In some embodiments the surface support has a locking pin that is retained by a latch mounted to a shelf unit when in the shelf configuration.

The convertible item can comprise at least one actuator or dampener for pivoting, or helping a person pivot in a safe and controlled manner, the shelf units into the shelf configuration or out of the shelf configuration. The actuator or dampener can control the pivot motion. The actuator or dampener can be controlled by a hand held remote or push button. The actuator or dampener can help offset the lift weight and also prevent the shelves from pivoting downwardly too quickly. The actuator or dampener can act as a locking mechanism.

In some embodiments, the linkage system or drive system can comprise at least one actuator or at least one pair of actuators for creating a lift assist. Thereby, less force may be needed to transition the item from one configuration to the other (eg. from a table to a set of shelves).

In some embodiments, the linkage system or drive system can comprise at least one actuator or at least one pair of actuators for slowing or otherwise controlling the transition, preferably the speed of transition, from one configuration to the other, independently of how much weight is placed on the shelves/leaves. This can make it safer for the user and also avoiding a hard stop at the end of the transition. In some embodiments, in the case that it is restricted in one direction, the table may be transitioned to a shelf more rapidly, for example.

Any suitable type of actuator can be used for lift assist. For example, a gas spring strut, rotary actuator or a rotary spring can be used and as otherwise described in the Description of Preferred Embodiments. In some embodiments, an actuator can extend between the frame member and part of the drive (eg. sprocket) and apply torque to that part of the drive (eg. sprocket), thereby creating a lift assist. Thus, less force is needed to transition the item. The gas spring strut can be positioned in such a way that when the item is transitioned into a table for example, the gas spring passes over centre and creates a small amount of torque in the opposite direction, thereby pushing the item into a table configuration. The item can have a mechanical stop that prevents it from rotating further than horizontal.

Any suitable type of actuator can be used for controlling the transition speed. For example, a gas dampener can be used. In some embodiments, an actuator can extend between the frame member and part of the drive (eg. sprocket) and apply torque to that part of the drive (eg. sprocket). Its function is to restrict the rotational speed of the sprocket in either one direction or both directions. This results in the item always transitioning slowly independently of how much weight is placed on the shelves/leaves, making it safer for the user and also avoiding a hard stop at the end of the rotation. In the case that it is restricted in one direction, the table may be transitioned to a shelf more rapidly.

In some embodiments, a single actuator or an actuator pair can have both a dampening function and a lift assist function.

In some embodiments the actuator is a gas strut having a first end connected to a surface support and a second end connected to the linkage system or drive system or a shelf unit. In some embodiments, the actuator is an electric actuator having a first end connected to a support surface and a second end connected to the linkage system or drive system or a shelf unit. In some embodiments the convertible item comprises two actuators. In some embodiments a pair of actuators is connected either to the primary linkage member pair or to the secondary linkage member pair. In some embodiments, the actuators can connect directly to the drive system.

In other embodiments the one or two or more actuators, gas strut, hydraulic strut or spring connected between the main support frame and the at least one shelf support member (eg. leave support) at a point that is offset to the main pivot axis of the at least one shelf support member (eg. leave support) such that as the shelf support member (eg. leave support) is activated during the transition from either a shelf configuration into a table configuration or from a table configuration into a shelf configuration, the at least one actuator, gas strut, hydraulic strut, dampener or spring exerts a restrictive force on the at least one shelf support member (eg. leave support) to inhibit or control the free fall motion of the convertible item from a vertical configuration to a substantially horizontal configuration. The at least one actuator, gas strut, hydraulic strut, dampener, cam or spring may also assist to reduce the load needed to transition the item from a substantially horizontal configuration into the vertical stacked shelve configuration.

In some embodiments, the surface support is in the form of a leg assembly comprising legs pivotally connected to the linkage system or drive system and/or shelf unit(s). A dampener, such as a gas strut can extend from an upper region of the legs to the linkage system or drive system and/or shelf unit. In another embodiment the legs may connected by way of a rotary damper. The legs can have ground-contacting wheels, castors, tracks or rollers. The legs can fold towards or against the shelf units when in the shelf configuration. The legs can extend away from the shelf units when the item is moved towards the substantially horizontal surface configuration and slow the downward movement by way of the dampener. In some embodiments, an electric actuator/motor could replace a dampener and be responsible for causing a dampening effect.

The convertible item can comprise a counterweight for helping a person safely pivot the shelf units into the shelf configuration. Any suitable type of counterweight can be used. In some embodiments a counterweight is installed on or adjacent a shelf unit at a front of the substantially horizontal support.

The convertible item can comprise an anti-tip mechanism so that the item is always balanced when moving between the different configurations. For example, the at least one surface support can have a leg assembly pivotally connected to the linkage system or drive system and/or shelf unit whereby legs of the leg assembly extend apart from each other when pivoting to the substantially horizontal surface configuration, and the legs move closer together when pivoting to the shelf configuration. The leg assembly can be configured similarly to that of a collapsible stroller for an infant.

Each shelf unit can be of any suitable size, shape and construction, and can be made of any suitable material or materials. For example, each shelf unit can be made of bamboo, wood (particleboard, chipboard, MDF, timber), composites, laminates, any printable material metal and/or plastics material.

Each shelf unit can be of similar construction or of differing construction. Each shelf unit can be of similar appearance or of differing appearance. Each shelf unit can be of any suitable length, width, height and thickness.

In some embodiments a, or each, shelf unit simply provides a leave for supporting one or more articles or items. In some embodiments a, or each, shelf unit is in the form of a tray, cupboard, cabinet, drawer or other closable compartment.

Each shelf unit comprises a substantially horizontally extending leave. Each leave remains substantially perfectly horizontal in any configuration, including when being transitioned between the substantially horizontal surface configuration and shelf configurations. This is so that any article or item placed on any of the leaves does not fall off whilst the shelves are being transitioned from a substantially horizontal table configuration to a vertically stacked configuration.

Preferably, the leave is longer than it is wide. That is, preferably the leave is elongate, having opposed longitudinal ends and opposed ends. Each leave can comprise a top surface, a bottom surface, oppose longitudinal ends, and opposed ends. Each leave can be in the form of a tray, panel or board, such as a wooden panel or board. If desired, the leave can be laminated.

In some embodiments, the leave can have one or more slots or slits for providing clearance for one or more linkage components of the linkage system or drive system when pivoting between the substantially horizontal surface (eg. table) and shelf configurations.

In some embodiments the leave can be discontinuous, being in separate pieces or sections. For example, the leave can comprise two, three, four, five, six or more spaced apart panels/panel sections.

In some embodiments, the linkage system or drive system can comprise a frame member extending between adjacent leave panels/panel sections each comprising a leave support, a drive can extend within the frame member, and a shaft can extend through the frame member from one leave support to the other, and the shaft can have a working region located within the frame member.

In some embodiments the leave support can comprise one or more side walls extending downwardly from the leave (much like shelf brackets or gussets), preferably vertically relative to the leave and preferably parallel with the frame member. In some embodiments the leave support can comprise spaced side walls extending downwardly from the leave, preferably vertically relative to the leave and preferably parallel with the frame member. In some embodiments the leave support can comprise one, two, three, four, five, six or even more side walls extending downwardly from the leave. Each side wall can be of integral construction with the leave or connectable to the leave. Each side wall can be in the form of a panel or board fastened to the leave by way of mechanical or non-mechanical fasteners, e.g. screws, nails, adhesive et cetera.

In embodiments where the leave is discontinuous, being in separate pieces or sections, one or more side walls may extend downwardly from each leave piece or section and preferably parallel with the frame member.

In some embodiments the leave support can comprise one or more rear walls extending downwardly from the leave and/or between adjacent side walls of the leave support. Preferably the rear wall extends vertically from the leave or vertically relative to the leave. In some embodiments a rear wall can extend from the leave to a side wall of the leave support. In some embodiments a rear wall can extend between the leave and each side wall of the leave support. The rear wall can be of integral construction with the leave and/or side walls or connectable to the leave and/or side wall/s. The rear wall can be in the form of a panel or board fastened to the leave and one or more side walls by way of mechanical or non-mechanical fasteners, e.g. screws, nails, adhesive et cetera.

In some embodiments, the rear wall can be shaped such that there is room for a person's knees beneath the substantially flat surface (e.g. table top) when seated at the substantially horizontal surface (e.g. table top). In some embodiments the rear wall can be tapered, arched or arcuate as it extends towards a periphery of the substantially horizontal surface (e.g. table top).

In some embodiments, the rear wall can have one or more slots or slits for providing clearance for one or more components of the linkage system or drive system when pivoting between the different configurations.

In some embodiments, one or more leave supports can comprise a drop-down lip or flap that can hide a gap or gaps between the leaves when in the shelf configuration. In some embodiments, a lip can extend upwardly to prevent items inside one or more of the shelves from falling out.

The convertible item can have any suitable number of shelf units. For example, the convertible item can have two, three, four, five, six, seven, eight, nine, 10, 11, 12 or even more shelf units. The number of shelf units will depend on factors such as the dimensions of the room in which the convertible item is to be located. For example, for rooms with standard ceiling heights, the convertible item (e.g. table and shelves) can have, for example, five, six, seven, eight, nine or 10 shelf units. Preferably the convertible item (e.g. table and shelves) has six, seven or eight shelf units. More preferably, the convertible item (e.g. table and shelves) has seven shelf units. If located within a vehicle, the convertible item can have, for example, three, four, five or six shelf units. If located within a vehicle, the support surface can itself be in the form of a cabinet, cupboard, set of drawers or other closable compartment.

One or more of the shelf units can have a secondary shelf located beneath the substantially horizontally extending leave (‘the main leave’). The secondary shelf can be dimensioned so as to be hidden beneath the substantially horizontal surface (e.g. table top) formed by the main leaves when in the substantially flat horizontal configuration, and the secondary shelf can be dimensioned so as to serve as a secondary accessible shelf when in the shelf configuration.

The secondary shelf can be of any suitable size, shape and construction, and can be made of any suitable material or materials. Each secondary shelf can be of any suitable length, width and height. Ideally, each secondary shelf will be made of the same material or materials as the shelf unit. Ideally, each secondary shelf will complement/match in with the overall look or appearance of the shelf unit.

The secondary shelf preferably has a substantially horizontally extending secondary leave. Preferably, the secondary leave is spaced beneath its main leave so as to accommodate one or more articles or items. Preferably, the secondary leave is longer than it is wide. That is, preferably the secondary leave is elongate having opposed longitudinal ends and opposed ends. Each secondary leave can comprise a top surface, a bottom surface, oppose longitudinal ends, and opposed ends. Each secondary leave can be in the form of a panel or board, such as a wooden panel or board.

The secondary shelf can have a secondary leave support for supporting the secondary leave. The secondary leave support can be of any suitable size, shape and construction, and can be made of any suitable material or materials. For example, each secondary leave support can be made of any printable material, bamboo, wood (particleboard, chipboard, MDF, timber), laminates, composites, metal and/or plastics material. The secondary leave support can in some embodiments be in the form of a shelf bracket or gusset.

In some embodiments the secondary leave support can comprise one or more side walls extending upwardly from the secondary leave (much like shelf brackets or gussets), preferably vertically relative to the secondary leave and preferably parallel with the frame member (although this need not be the case). In some embodiments the side wall can extend from the secondary leave to the main leave. In some embodiments the secondary leave support can comprise spaced side walls extending upwardly from the secondary leave, preferably vertically relative to the leave and preferably parallel with the frame member (although this need not be the case). In some embodiments the secondary leave support can comprise one, two, three, four, five, six or even more side walls extending from the secondary leave. Each side wall can be of integral construction with the secondary leave or connectable to the secondary leave. Each side wall can be of integral construction with the main leave or connectable to the main leave. Each side wall can be in the form of a panel or board fastened to the secondary leave by way of mechanical or non-mechanical fasteners, e.g. screws, nails, adhesive et cetera.

In some embodiments the secondary leave support can comprise one or more rear walls extending upwardly from the secondary leave and/or between adjacent side walls of the secondary leave support and/or to the main leave. Preferably the rear wall extends vertically from the secondary leave or vertically relative to the secondary leave. In some embodiments a rear wall can extend upwardly from the secondary leave. In some embodiments a rear wall can extend upwardly from the secondary leave to the main leave. In some embodiments a rear wall can extend from the secondary leave to a side wall of the secondary leave support. In some embodiments a rear wall can extend between the secondary leave and each side wall of the secondary leave support. In some embodiments a rear wall can extend between the secondary leave and main leave, and each side wall of the secondary leave support. The rear wall can be of integral construction with the secondary leave and/or main leave and/or side wall/s or connectable to a leave/s and/or side wall/s. The rear wall can be in the form of a panel or board fastened to the secondary and/or main leave and one or more side walls by way of mechanical or non-mechanical fasteners, e.g. screws, nails, adhesive et cetera.

In some embodiments the leave support and secondary leave support or components thereof are one and the same. In some embodiments one or more side walls of the leave support and one or more side walls of the secondary leave support are one and the same. In some embodiments the rear wall of the leave support and the rear wall of the secondary leave support are one and the same.

In some embodiments, the rear wall of the secondary leave support can be shaped such that there is room for a person's knees beneath the substantially flat surface (e.g. table top) when seated at the substantially flat surface (e.g. table top). In some embodiments the rear wall can be tapered, arched or arcuate as it extends towards a periphery of the substantially flat surface (e.g. table top).

As mentioned above, in some embodiments a, or each, shelf unit can comprise one or more trays, doors or slidable drawers for forming a cabinet, cupboard, set of drawers or other closable compartment. In some embodiments a, or each, secondary shelf unit can comprise one or more trays, doors for forming a cabinet, cupboard or other closable compartment. The one or more doors can be hinged or slidable for movement between open and closed positions. The one or more doors can be hinged or slidable for movement relative to a leave or leave support. In some embodiments a, or each, secondary shelf unit can comprise one or more slidable trays or drawers for forming a set of drawers.

In some embodiments a, or each, shelf or secondary shelf unit can comprise a hanging rail or rod, or rope, wire or elastic retainer extending between the side walls.

In some embodiments, each secondary leave support can be connected or connectable to a rotatable shaft of the linkage system or drive system. In some embodiments, each secondary leave support can have an opening for receiving a respective rotatable shaft of the linkage system or drive system. In some embodiments, the secondary leave support is in the form of a casting, such as a triangular casting fastened to the secondary leave and having an opening for receiving a shaft of the linkage system or drive system. The casting can be made of metal.

In some embodiments, where the item is configurable as a table, the item can comprise a table leg assembly connected to one said shelf unit or to the linkage system or drive system. In some embodiments, the table leg assembly can be located approximately midway between the front and rear ends of the substantially horizontal surface/table top. In some embodiments, the table leg assembly can be located at or near to a front end or at or near to a rear end of the substantially horizontal surface/table top. The table leg assembly can be mountable or fixable to a ground surface or fixture, or not.

In some embodiments where the item is configurable as a table, the item can comprise two table leg assemblies. A front table leg assembly can be connected to one said shelf unit or to the linkage system or drive system at or near to the front end of the table top, and a rear table leg assembly can be connected to another said shelf unit or to the linkage system or drive system at or near to the rear end of the table top. The table leg assemblies can be mountable or fixable to a ground surface or fixture, or not. In some embodiments, there can be leg room for a person seated at the table top adjacent a first said shelf unit. In some embodiments, there can be leg room for a person seated at the table top adjacent a second said shelf unit.

The front table leg assembly can be of any suitable size, shape and construction, and can be made of any suitable material or materials. The front table leg assembly can be connected to a shelf unit and/or linkage system or drive system at or near to the front end of the table top in any suitable way. For example, one or more mechanical or non-mechanical fasteners can be used to connect an upper part of the front table leg assembly to the shelf unit or linkage system or drive system. If connected to a linkage member, then this may be achieved using a connecting pin or screw.

The front table leg assembly can have a lower part that rests upon the ground/ground surface (eg. floor, concrete slab, earth et cetera).

In some embodiments, the front table leg assembly is in the form of a pair of spaced apart substantially vertical legs with an upper part of each leg being connected to a shelf unit or to the linkage system or drive system, and a foot extending from a lower part of each vertical leg. The front table leg assembly can further comprise reinforcements such as a cross piece extending between the vertical legs and/or a gusset extending between the vertical leg and foot. In preferred embodiments, the front table leg assembly is made of elongate tubular members connected together. In some embodiments an end of the first and/or second linkage members can rest against the foot when in the shelf configuration.

The convertible table and shelves can be movable from one location to another and this can be achieved in any suitable way. In some embodiments, the convertible table and shelves has one or more wheels for moving the convertible table and shelves from one location to another. In some embodiments the front table leg assembly comprises one or more rollers, wheels or casters for wheeling the convertible table and shelves from one location to another, preferably when in its shelf configuration. Preferably, a caster or wheel or a caster or wheel pair is pinned to each foot of the front table leg assembly.

The rear table leg assembly can be of any suitable size, shape and construction, and can be made of any suitable material or materials. The rear table leg assembly can be connected to a shelf unit and/or the linkage system or drive system at or near to the rear end of the table top in any suitable way. For example, one or more mechanical or non-mechanical fasteners can be used to connect an upper part of the rear table leg assembly to the shelf unit and/or linkage system or drive system. If connected to the linkage system or drive system, then this may be achieved using a connecting pin or screw.

The rear table leg assembly can have a lower part that rests upon the ground/ground surface (eg. floor, concrete slab, earth et cetera), but only when in the table configuration.

In some embodiments, the rear table leg assembly is in the form of a pair of spaced apart substantially vertical legs with an upper part of each leg being connected to a shelf unit and/or linkage system or drive system. The rear table leg assembly can further comprise reinforcements such as a cross piece extending between the vertical legs. When in the shelf configuration, the rear table leg assembly need not rest against the ground surface. In preferred embodiments, the rear table leg assembly is made of elongate tubular members connected together.

The convertible table and shelves can comprise a holding or locking mechanism for holding or locking the convertible table and shelves in the shelf configuration and/or in the table configuration, such that the linkage mechanism cannot allow pivoting from one configuration to the other. Any suitable holding or locking mechanism can be used. In some embodiments this involves a magnet, electro magnet, locking pin or latch. In some embodiments the rear table leg assembly has a locking pin that is retained by a latch mounted to a shelf unit when in the shelf configuration. The locking mechanism can be an actuator as described above.

The convertible table and shelves are arranged and operate in a such a way that when in the substantially horizontal table configuration there is convenient and substantially un-hindered access from substantially all sides of the table for chairs, stools, benches or other such similar furniture designed for sitting on, to be placed under the convertible table and further that when people are using such chairs as described herein there is substantially un-hindered access for a person to sit at the table without interference from the convertible table. The convertible table and shelf unit is further so arranged and configured in some embodiments so that when it is in either the substantially horizontal table configuration or the vertically stacked configuration there is convenient access to the majority of the floor footprint located directly under the suspended exterior envelope of the unit to enable cleaning of the floor by any suitable method including by way of a mop, broom, self-propelled automated vacuum cleaner, duster or similar device, without the need to navigate over or around structural or support members being situated in a location at or close to ground level and substantially in vertical alignment with the vertically suspended and supported envelope of the convertible table and shelve unit.

The convertible table and shelves can comprise a counterweight for helping a person pivot the shelf units into the shelf configuration. Any suitable type of counterweight can be used. In some embodiments a counterweight is installed on or adjacent a shelf unit at a front of the table top.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Description of Embodiments which provides sufficient information for those skilled in the art to perform the invention. The Description of Embodiments is not to be regarded as limiting the scope of the preceding Summary of the Invention in any way. The Description of Embodiments will make reference to a number of drawings as follows:

FIG. 1 is a top front perspective view of a convertible table and shelves in a table configuration, according to a first embodiment of the present invention.

FIG. 2 is a front perspective view of the convertible table and shelves shown in FIG. 1 but in a shelf configuration.

FIG. 3 is a front perspective view of the convertible table and shelves shown in FIG. 1 when being transitioned between the table and shelf configurations.

FIG. 4 is a front view of the convertible table and shelves shown in FIG. 1 when in a table configuration.

FIG. 5 is a side elevation view of the convertible table and shelves shown in FIG. 1 when in a table configuration.

FIG. 6 is a front view of the convertible table and shelves shown in FIG. 2 when in a shelf configuration.

FIG. 7 is a side elevation view of the convertible table and shelves shown in FIG. 2 when in a shelf configuration.

FIG. 8 is a rear perspective view of the convertible table and shelves shown in FIG. 1 when being transitioned between the table and shelf configurations.

FIG. 9 is a side elevation view of the convertible table and shelves shown in FIG. 1 when being transitioned between the table and shelf configurations.

FIG. 10 is a top front perspective view of a convertible table and shelves in a table configuration, according to a second embodiment of the present invention.

FIG. 11 is a front perspective view of the convertible table and shelves shown in FIG. 10 but in a shelf configuration.

FIG. 12 is a front perspective view of the convertible table and shelves shown in FIG. 10 when being transitioned between the table and shelf configurations.

FIG. 13 is a rear view of the convertible table and shelves shown in FIG. 10 when in a table configuration.

FIG. 14 is a side elevation view of the convertible table and shelves shown in FIG. 10 when in a table configuration.

FIG. 15 is a front view of the convertible table and shelves shown in FIG. 11 when in a shelf configuration.

FIG. 16 is a side elevation view of the convertible table and shelves shown in FIG. 11 when in a shelf configuration.

FIG. 17 is a rear view of the convertible table and shelves shown in FIG. 10 when in a shelf configuration.

FIG. 18 is a rear perspective view of the convertible table and shelves shown in FIG. 10 when being transitioned between the table and shelf configurations.

FIG. 19 is a side elevation view of the convertible table and shelves shown in FIG. 10 when being transitioned between the table and shelf configurations.

FIG. 20 is a top front perspective view of a convertible bed/mattress base and shelves in a base configuration, according to a third embodiment of the present invention.

FIG. 21 is a front perspective view of the convertible bed/mattress base and shelves shown in FIG. 20 but in a shelf configuration.

FIG. 22 is a front perspective view of the convertible bed/mattress base and shelves shown in FIG. 20 when being transitioned between the base and shelf configurations.

FIG. 23 is a front view of the convertible bed/mattress base and shelves shown in FIG. 20 when in a base configuration.

FIG. 24 is a side elevation view of the convertible bed/mattress base and shelves shown in FIG. 20 when in a base configuration.

FIG. 25 is a front view of the convertible bed/mattress base and shelves shown in FIG. 20 when in a shelf configuration.

FIG. 26 is a side elevation view of the convertible bed/mattress base and shelves shown in FIG. 20 when in a shelf configuration.

FIG. 27 is a side elevation view of the convertible bed/mattress base and shelves shown in FIG. 20 when being transitioned between the base and shelf configurations.

FIG. 28 is a front perspective view of a convertible bed/mattress base and shelves in a shelf configuration, similar to that shown in FIG. 20, according to a fourth embodiment of the present invention.

FIG. 29 is a perspective view of a convertible workbench and shelves in a shelf configuration, installed in a vehicle, similar to the convertible bed/mattress base and shelves shown in FIG. 20, according to a fifth embodiment of the present invention.

FIG. 30 is a perspective view of the convertible workbench and shelves shown in FIG. 29 when being transitioned between the workbench and shelf configurations.

FIG. 31 is a perspective view of the convertible workbench and shelves shown in FIG. 29 but in a workbench configuration.

FIG. 32 is a perspective view of a shelf unit of part of a convertible item of furniture, according to a sixth embodiment of the present invention.

FIG. 33 is a perspective view of a shelf unit of part of a convertible item of furniture, according to a seventh embodiment of the present invention.

FIG. 34 is a top front perspective view of a convertible desk and shelves in a desk configuration, according to an eighth embodiment of the present invention.

FIG. 35 is a front perspective view of the convertible desk and shelves shown in FIG. 34 but in a shelf configuration.

FIG. 36 is a front perspective view of the convertible desk and shelves shown in FIG. 34 when being transitioned between the desk and shelf configurations.

FIG. 37 is a front view of the convertible desk and shelves shown in FIG. 34 when in a desk configuration.

FIG. 38 is a side elevation view of the convertible desk and shelves shown in FIG. 34 when in a desk configuration.

FIG. 39 is a front view of the convertible desk and shelves shown in FIG. 34 when in a shelf configuration.

FIG. 40 is a side elevation view of the convertible desk and shelves shown in FIG. 34 when in a shelf configuration.

FIG. 41 is a side elevation view of the convertible desk and shelves shown in FIG. 34 when being transitioned between the desk and shelf configurations.

FIG. 42 is a top front perspective view of a convertible desk and shelves in a desk configuration similar to that shown in FIG. 34, according to a ninth embodiment of the present invention.

FIG. 43 is a top front perspective view of a convertible gaming table and shelves in a gaming table configuration, according to a tenth embodiment of the present invention.

FIG. 44 is a front perspective view of the convertible gaming table and shelves shown in FIG. 43 but in a shelf configuration.

FIG. 45 is a front perspective view of the convertible gaming table and shelves shown in FIG. 43 when being transitioned between the gaming table and shelf configurations.

FIG. 46 is a front view of the convertible gaming table and shelves shown in FIG. 43 when in a gaming table configuration.

FIG. 47 is a side elevation view of the convertible gaming table and shelves shown in FIG. 43 when in a gaming table configuration.

FIG. 48 is a front view of the convertible gaming table and shelves shown in FIG. 43 when in a shelf configuration.

FIG. 49 is a side elevation view of the convertible gaming table and shelves shown in FIG. 43 when in a shelf configuration.

FIG. 50 is a side elevation view of the convertible gaming table and shelves shown in FIG. 43 when being transitioned between the desk and shelf configurations.

FIG. 51 is a top front perspective view of a convertible desk and shelves in a desk configuration, according to an eleventh embodiment of the present invention.

FIG. 52 is a front perspective view of the convertible desk and shelves shown in FIG. 51 but in a shelf configuration.

FIG. 53 is a front perspective view of the convertible desk and shelves shown in FIG. 51 when being transitioned between the desk and shelf configurations.

FIG. 54 is a front view of the convertible desk and shelves shown in FIG. 51 when in a desk configuration.

FIG. 55 is a side elevation view of the convertible desk and shelves shown in FIG. 51 when in a desk configuration.

FIG. 56 is a front view of the convertible desk and shelves shown in FIG. 51 when in a shelf configuration.

FIG. 57 is a side elevation view of the convertible desk and shelves shown in FIG. 51 when in a shelf configuration.

FIG. 58 is a partially detailed side elevation view of the convertible desk and shelves shown in FIG. 51 when being transitioned between the desk and shelf configurations.

FIG. 59 is a bottom perspective view of part of a convertible item in a substantially horizontal surface configuration, according to an embodiment of the present invention.

FIG. 60 is a side perspective view of that shown in FIG. 59 but almost in a shelf configuration, according to an embodiment of the present invention.

FIG. 61 is a bottom perspective view of part of a convertible item in a substantially horizontal surface configuration, according to an embodiment of the present invention.

FIG. 62 is a bottom perspective view of part of a convertible item not quite in the horizontal surface configuration, according to an embodiment of the present invention.

FIG. 63 is a bottom perspective view of part of a convertible item not quite in the horizontal surface configuration, according to an embodiment of the present invention.

FIG. 64 is a top perspective view of part of a convertible item not quite in the horizontal surface configuration, according to an embodiment of the present invention.

FIG. 65 is a side perspective view of part of a convertible item not quite in the shelf configuration, according to an embodiment of the present invention.

FIG. 66 is a side perspective view of part of a convertible item not quite in the horizontal surface configuration, according to an embodiment of the present invention.

FIG. 67 is a side perspective view of part of a convertible item not quite in the shelf configuration, according to an embodiment of the present invention.

FIG. 68 is a side perspective view of part of a convertible item not quite in the shelf configuration, according to an embodiment of the present invention.

FIG. 69 is a side perspective view of part of a convertible item not quite in the shelf configuration, according to an embodiment of the present invention.

FIG. 70 is a side perspective view of part of a convertible item not quite in the shelf configuration, according to an embodiment of the present invention.

FIG. 71 is a side perspective view of part of a convertible item not quite in the shelf configuration, according to an embodiment of the present invention.

FIG. 72 is a side view of a convertible item of furniture (garage table/workbench) in the shelf configuration, according to an embodiment of the present invention.

FIG. 73 is a side view of the convertible item of furniture of FIG. 72, moving out of the shelf configuration, according to an embodiment of the present invention.

FIG. 74 is a side view of the convertible item of furniture of FIG. 72, in the horizontal surface configuration, according to an embodiment of the present invention.

FIG. 75 is a perspective view of that shown in FIG. 73.

FIG. 76 is top side perspective view of the item shown in FIG. 74.

FIG. 77 is a detailed/sectional side view of a convertible item of furniture (dining table), in the horizontal surface configuration, according to an embodiment of the present invention.

FIG. 78 shows the item of FIG. 77, but in the shelf configuration.

FIG. 79 is a perspective view of the item shown in FIG. 78, except without an anti-tip support leg, according to an embodiment of the present invention.

FIG. 80 is a perspective view of the item shown in FIG. 79, except shown in the horizontal surface configuration.

FIG. 81 is a rear perspective view of an item shown in the shelf configuration, according to another embodiment of the present invention.

FIG. 82 is a top perspective view of the item shown in FIG. 81, except shown in the substantially horizontal surface configuration.

FIG. 83 is a top side perspective view of a convertible item, according to another embodiment of the present invention.

FIG. 84 is an enlarged view of part of the item shown in FIG. 83.

FIG. 85 is a side perspective view of a convertible item, according to another embodiment of the present invention.

FIG. 86 is an enlarged view of part of the item shown in FIG. 85.

FIG. 87 is a side perspective view of a convertible item, according to another embodiment of the present invention.

FIG. 88 is an enlarged view of part of the item shown in FIG. 87.

FIG. 89 is a side perspective view of a convertible item (pallet racking system), in a shelf configuration, according to an embodiment of the present invention.

FIG. 90 shows the item of FIG. 89, but in transition between different configurations.

FIG. 91 is a perspective view of the item shown in FIG. 89, except shown in a horizontal surface configuration.

FIG. 92 is a rear perspective view of a convertible item, according to another embodiment of the present invention.

FIG. 93 is a side view of the convertible item of FIG. 92, in a shelf configuration.

FIG. 94 is a side view of the convertible item of FIG. 92, when moving from the shelf configuration.

FIG. 95 is a side view of the convertible item of FIG. 92, in a horizontal surface configuration.

### DESCRIPTION OF EMBODIMENTS

In the figures like reference numerals refer to like features.

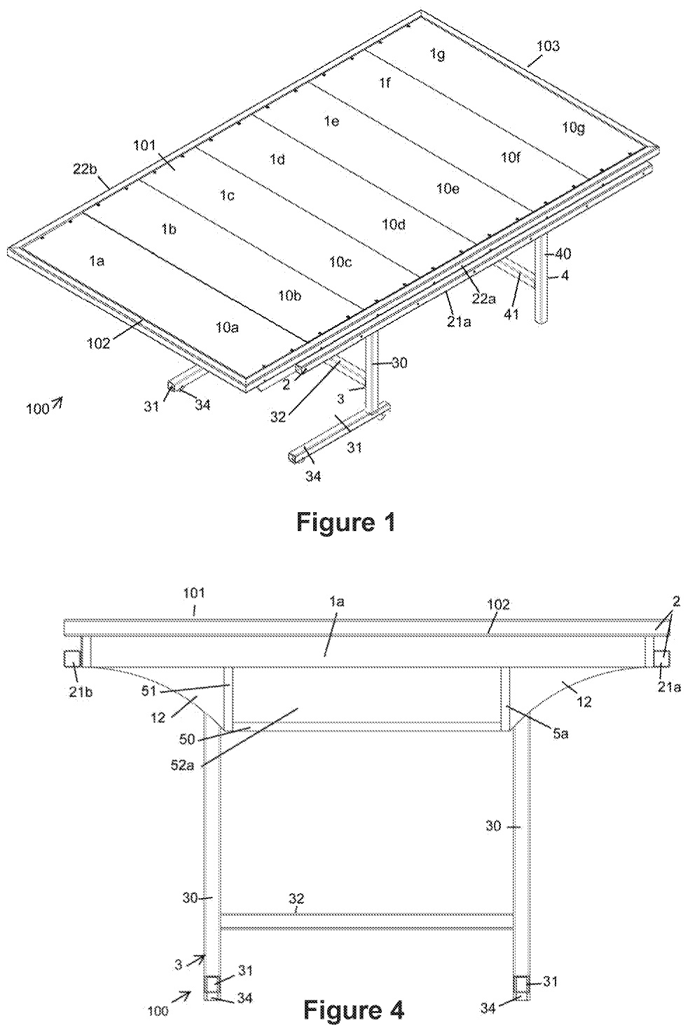

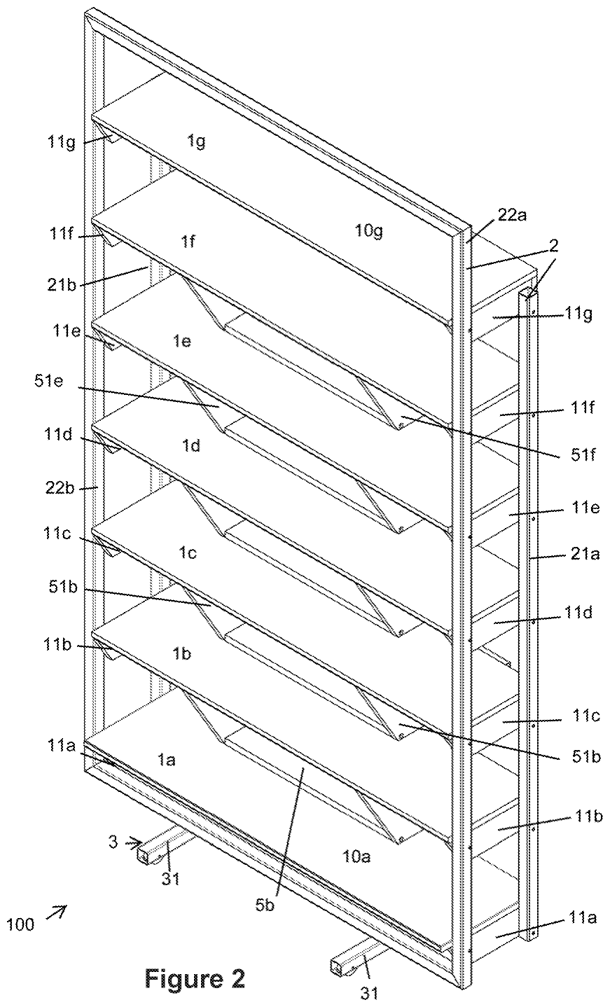

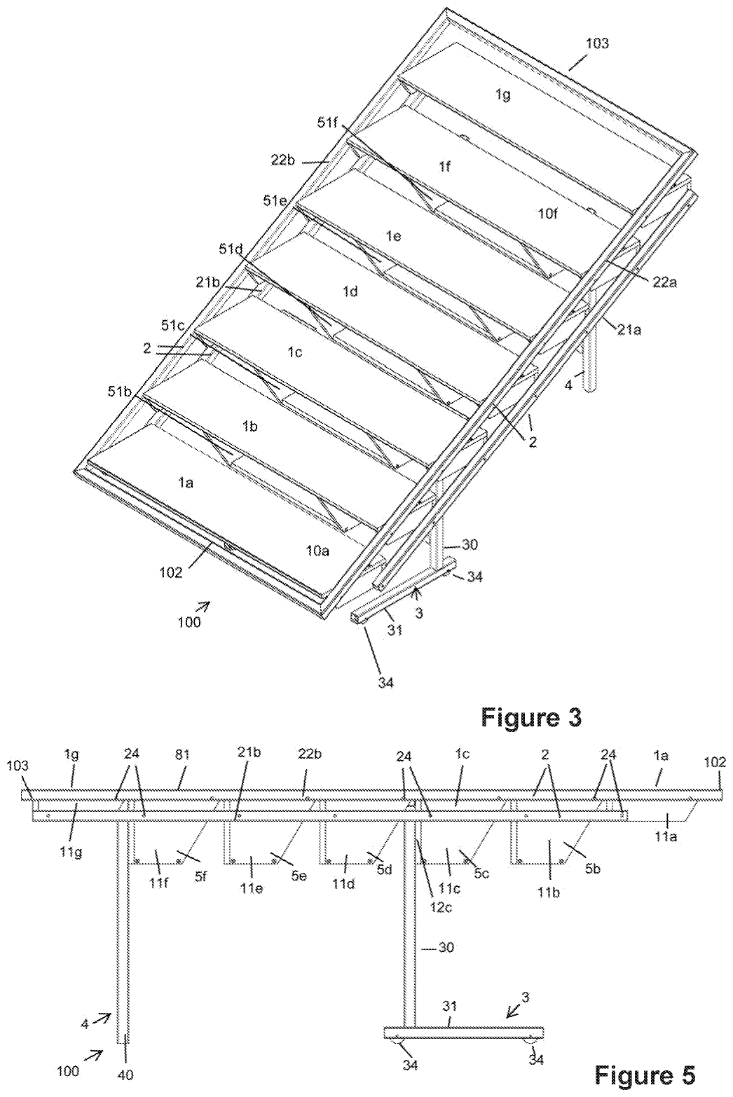

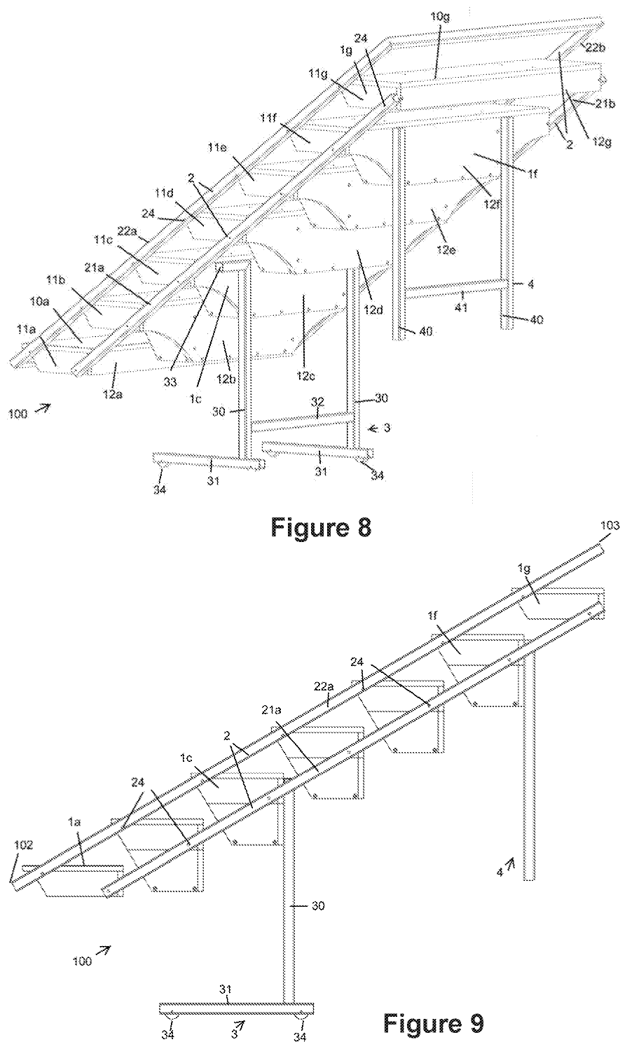

Referring first to FIGS. 1-9, there is shown a convertible table and shelves 100 that is configurable either as a table having a table top 101 (ie. substantially flat surface) as seen in FIG. 1 or shelves as seen in FIG. 2.

The convertible table and shelves 100 includes first 1a, second 1b, third 1c, fourth 1d, fifth 1e, sixth 1f and seventh 1g shelf units 1, a linkage system 2 comprising a primary linkage member pair 21a, 21b and a secondary linkage member pair 22a, 22b pivotally connected to each shelf unit 1, a front table leg assembly 3 connected to the third shelf unit 1c, and a rear table leg assembly 4 connected to the sixth shelf unit 1f.

Each shelf unit 1 comprises a substantially horizontally extending leave 10a-10g and a leave support including a pair of spaced apart side walls 11a-11g extending downwardly from the leave 10a-10g and a rear wall 12a-12g extending between the leave 10a-10g and the side walls 11a-11g. The side walls 11a-11g extend parallel with the linkage members 21, 22 and perpendicularly of the leaves 10. The rear walls 12 extend vertically between the side walls 11.

Shelf units 1b, 1c, 1d, 1e and 1f each have a secondary shelf 5b-5f located beneath the main leave 10. The secondary shelf 5 is dimensioned so as to be hidden beneath the table top 101 formed by the main leaves 10 of the shelf units 1 when in the table configuration, and the secondary shelf 5 is dimensioned so as to serve as an additional accessible shelf when in the shelf configuration.

The shelf units 1 and secondary shelves 5 are wooden panels or boards (in some embodiments laminated) fastened together with mechanical fasteners such as screws and optionally non-mechanical fasteners such as adhesive.

Each secondary shelf 5 includes a substantially horizontally extending secondary leave 50b-50f and a pair of spaced apart secondary side walls 51b-51f (not all of which have been labelled) extending between the main leave 10 and the secondary leave 50. The rear wall 12 of the shelf unit 1 extends to the secondary leave 50.

The first 1a and seventh 1g shelf units 1 do not have a secondary shelf 5 so that a person seated at the front 102 or rear end 103 of the table top 101 has leg/knee room beneath the table top 101. Rear walls 12b-12f are arched so as to provide leg/knee room beneath the tabletop 101. (The first 1a and seventh 1g shelf units 1 do have side walls but no leaves.)

Each of the primary linkage member pair 21a, 21b and each of the secondary linkage member pair 22a, 22b is a straight elongate tubular member of rectangular cross-section. The tubular members 22 are made of metal. These tubular members 22 have openings through which pivot pins/fastening pins 24 (only some of which are labelled in FIG. 5) extend and fasten within a side wall 11 of a shelf unit 1. In this way, the tubular members 22 are pinned for pivotal movement relative to the shelf units 1.

The primary 21 and secondary 22 linkage member pairs are able to pivot in unison and parallel with each other between (1) a shelf configuration (see FIGS. 2, 6 and 7) whereby the primary 21 and secondary 22 linkage member pairs extend substantially vertically and the leaves 10, 50 extend in spaced substantially horizontal parallel planes above one another, and (2) a table configuration (see FIGS. 1, 4 and 5) whereby the primary 21 and secondary 22 linkage member pairs extend substantially horizontally and the leaves 10 extend next to one another in substantially the one and the same substantially horizontal place to form a table top 101.

The secondary linkage member pair 22 is part of table frame (comprising elongate tubular members) that further extends around a periphery of the table top 101, as seen in FIG. 1.

The front table leg assembly 3 includes a pair of vertically extending legs 30, a foot 31 extending perpendicularly and forwardly from a lower region of each leg 30, a cross piece 32 extending between the legs 30, and a lateral mount 33 extending laterally from an upper region of each leg 30. Each leg 30, foot 31, cross piece 32 and mount 33 is a straight elongate tubular member of rectangular cross-section. Each foot 31 has a pair of pinned wheels 34, enabling the table 100 when in the shelf configuration to be wheeled from one location to another. The mount 33 and leg 30 are each connected to the third shelf unit's rear wall 12c and leave 10c by way of screws.

The rear table leg assembly 4 includes a pair of vertically extending legs 40 and a cross piece 41 extending between the legs 40. Each leg 40 and cross piece 41 is a straight elongate tubular member of rectangular cross-section. Each leg 40 is connected to the sixth shelf unit's rear wall 12f by way of screws.

Although not shown, the convertible table and shelves 100 includes a locking mechanism for locking the rear table leg assembly 4 to a shelf unit 1 such that there is no possibility of the shelf units 1 swinging downwardly by accident into the table configuration. In one embodiment a locking pin extends from a vertically extending leg 40 and the pin is releasably retained by a latch that is mounted to a shelf unit 1.

The convertible table and shelves 100 can also have a counterweight (not illustrated) connected to the first shelf unit 1a for helping raise the shelf units 1 into the shelf configuration.

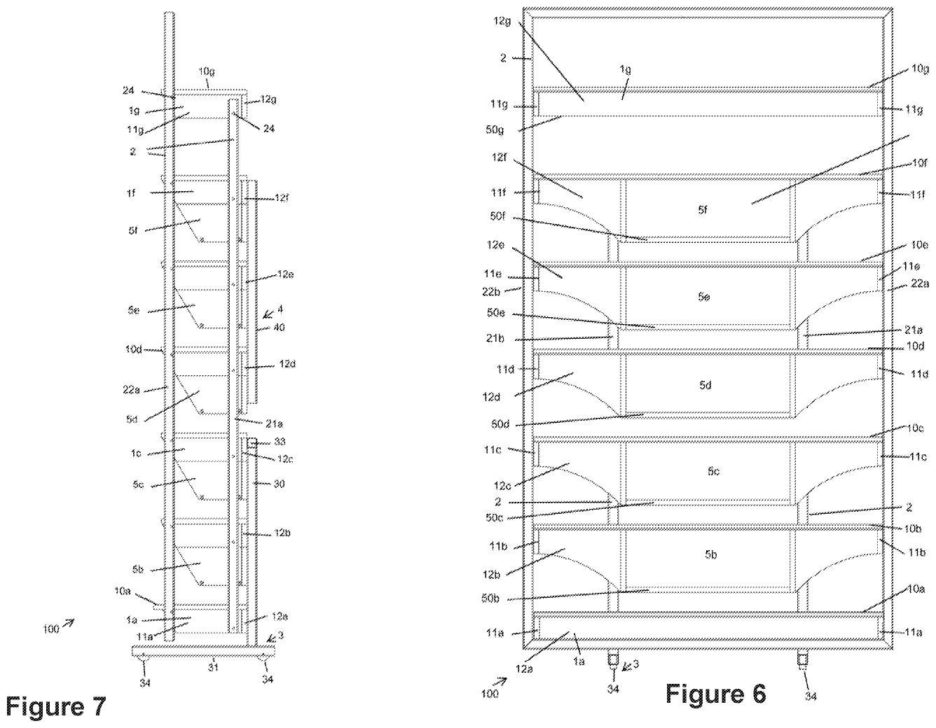

In use, the configurable table and shelves 100 can be configured as a table shown in FIG. 1 or configured as shelves as shown in FIG. 7. In order to change from the table configuration to the shelf configuration, a person raises the rear end 103 of the table top 101 so that the shelf units 1 swing into the shelf configuration shown in FIG. 7. When in the shelf configuration, the feet 31 of the front table leg assembly 3 extend beneath the shelf units 1, and the rear table leg assembly 4 is suspended above the ground. The locking mechanism stops the linkage system 2 from pivoting by accident. Moreover, the rear table leg assembly 4 extends in substantially the same vertical plane as the front table leg assembly 3—i.e. in a compact state. When in the shelf configuration, as seen in FIG. 6, articles or items placed on the main leave 10 and secondary leave 50 can be accessed. When in the table configuration, items in the secondary leave 50/secondary shelf 5 are hidden from view beneath the table top 101.

In this first embodiment the front 3 and rear 4 table leg assemblies are each connected to shelf units 1c, 1f, as opposed to being connected to the linkage members 21, 22. In view of these table leg assemblies 3, 4 being connected at a distance from the periphery of the table top 101/table frame, there is leg room for a person seated at the table top 101 adjacent these shelf units 1c, 1f. The rear wall 12 of each shelf unit 1 and additional shelf 5 is also tapered (arched) so as to provide additional room for that person's knees, as seen in FIG. 4.

An advantage of the invention according to the first embodiment is that the table leg assemblies 3, 4 are not directly connected to the linkage members 21, 22 and in this way can be recessed relative to the periphery of the table top 101, to provide legroom for a person seated at the table. If, on the other hand, should the table leg assemblies 3, 4 be connected directly to the linkage members 21, 22, then a person seated at that location would not have adequate legroom. This means that the convertible table and shelves can be used to seat more than two people at any given time.

Another advantage of the invention according to the first embodiment is that the secondary shelf 5 can be used to hide items or articles when in the table configuration, but when in the shelf configuration those hidden articles or items can be accessed. This means that the convertible table and shelves can be conveniently used as a dining table, whereby items can be hidden when dining.

Another advantage of the present invention is that the table leg assemblies 3, 4 are not located midway between the front and rear ends of the table top 101. This means that the invention can accommodate further shelf units, if desired.

Yet another advantage of the invention according to the first embodiment is that in the shelf configuration it has a narrow footprint, which allows it to be placed/stored close against a wall.

The invention according to the first embodiment overcomes one or more other disadvantages referred to in the Background Section of this specification.

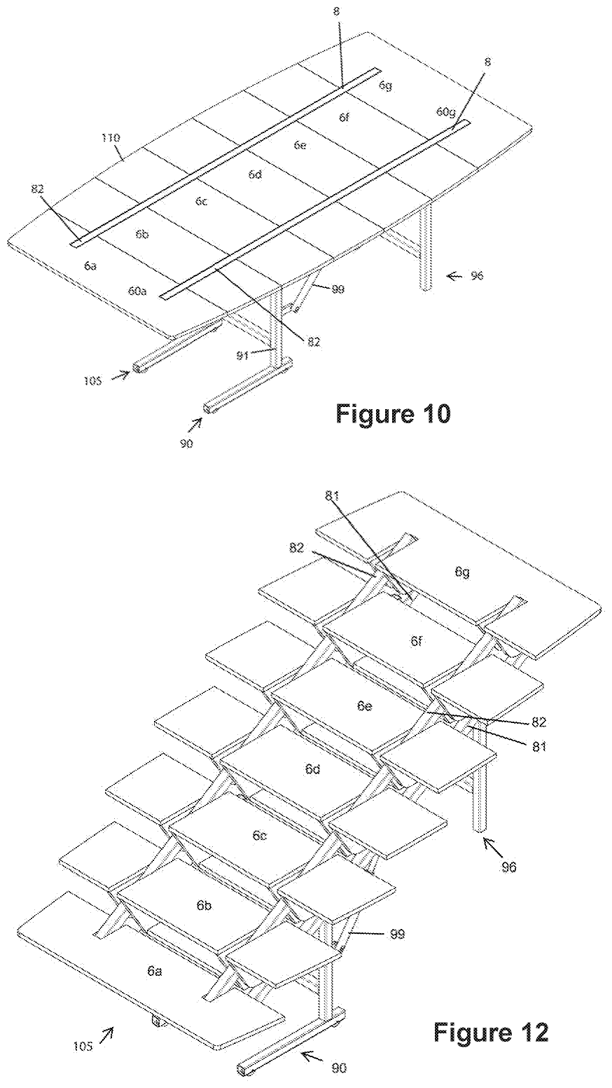

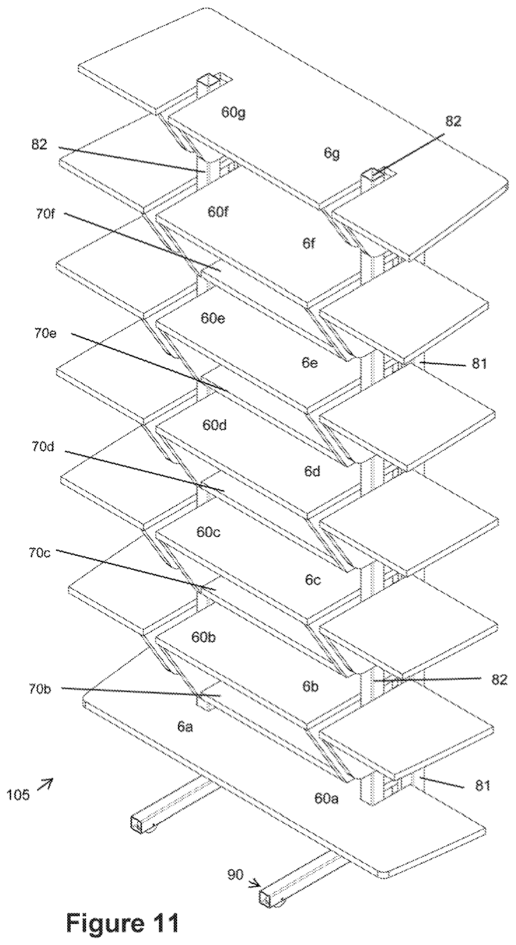

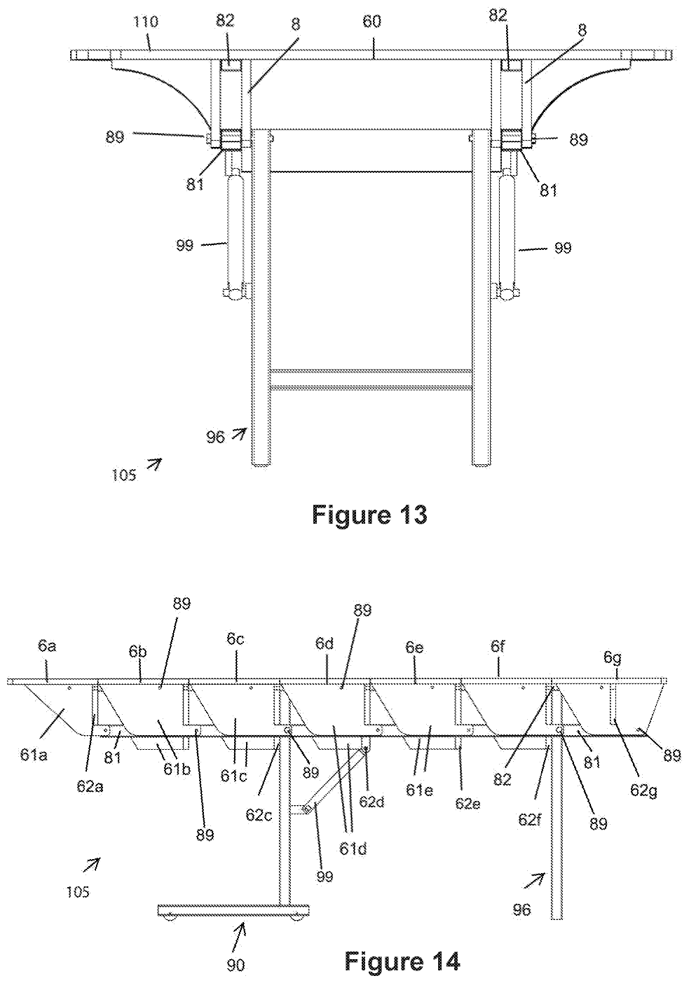

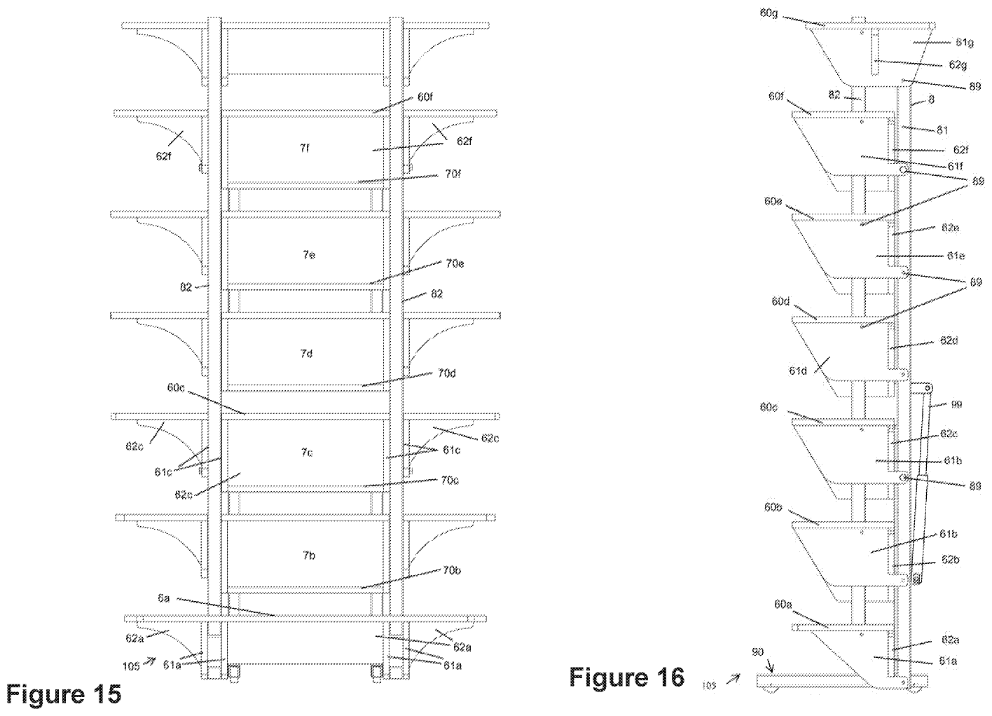

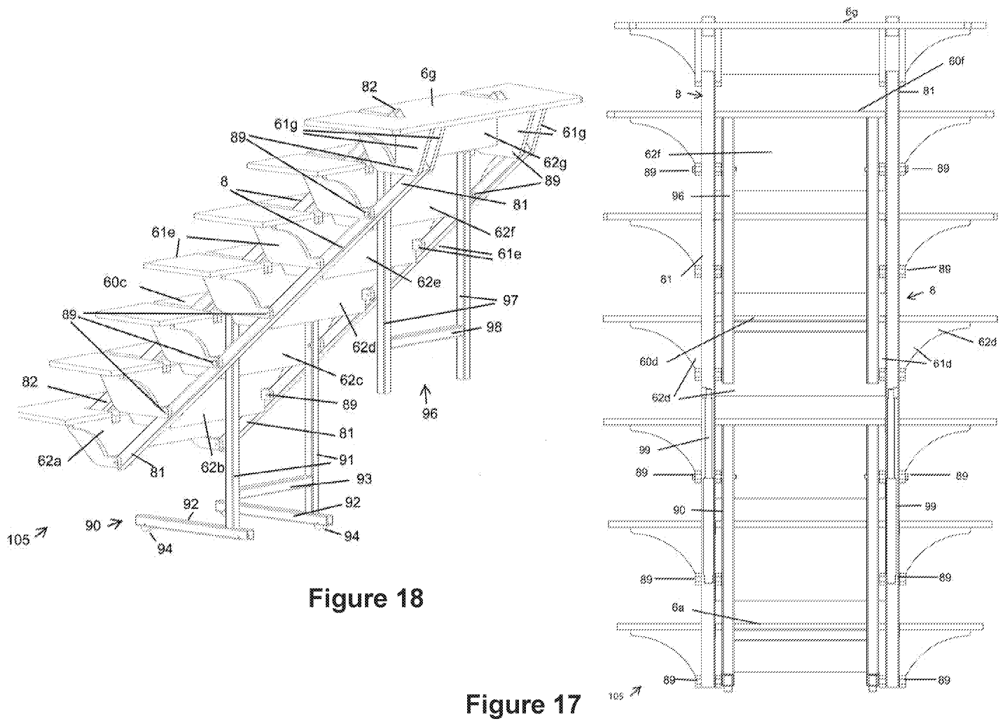

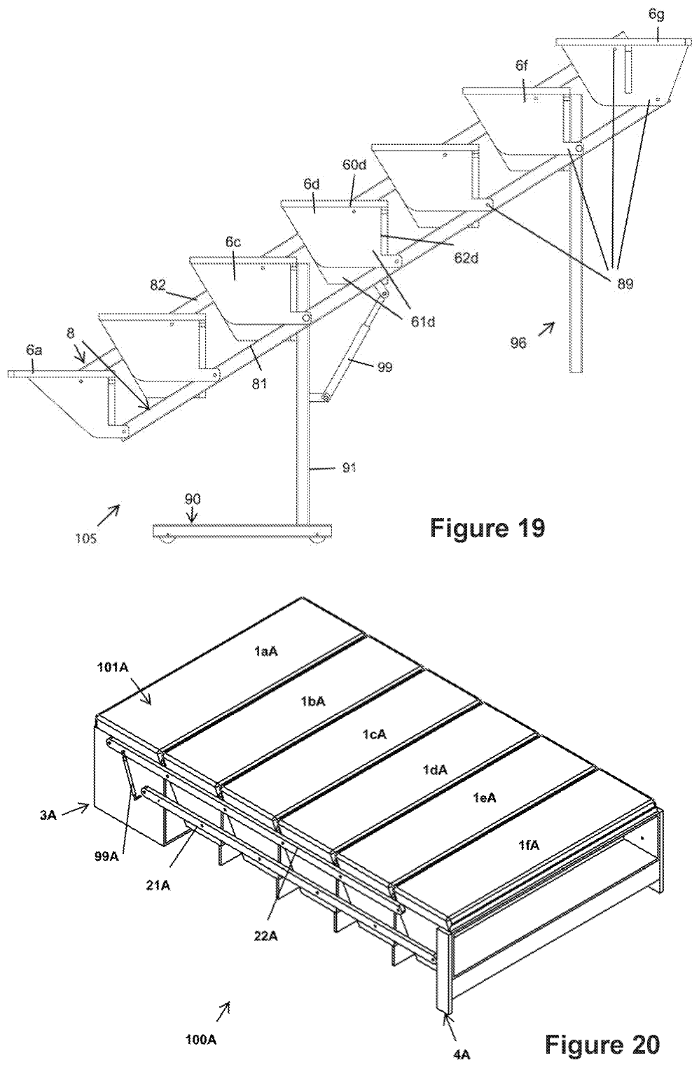

Referring now to FIGS. 10-19, there is shown a convertible table and shelves 105 that is configurable either as a table having a table top 110 as seen in FIG. 10 or shelves as shown in FIG. 11.

The convertible table and shelves 105 includes first 6a, second 6b, third 6c, fourth 6d, fifth 6e, sixth 6f and seventh 6g shelf units 6, a linkage system 8 comprising a primary linkage member pair 81 and a secondary linkage member pair 82 pivotally connected to each shelf unit 6, a front table leg assembly 90 connected to the primary linkage member pair 81 at the third shelf unit 6c, a rear table leg assembly 96 connected to the primary linkage member pair 81 at the sixth shelf unit 6f, and a pair of actuators 99 (not shown in all of the Figures).

Each shelf unit 6 includes a substantially horizontally extending leave 60a-60g and a shelf support including spaced apart side walls 61a-61g extending downwardly from the leave 60, and a rear wall 62a-62g extending between the leave 60 and the side walls 61 (similar to the first embodiment).

The first shelf unit 6a has a leave 60a having two slits for accommodating the secondary linkage pair 82. The first shelf unit 6a has two pairs of spaced side walls 61a between which the primary 81 and secondary linkage pairs 82 extend. The first shelf unit 6a has a rear wall 62a having two slits for accommodating the secondary linkage pair 82.

The seventh shelf unit 6g has a leave 60g having two slits for accommodating the secondary linkage pair 82. The seventh shelf unit 6g has two pairs of spaced side walls 61g between which the primary 81 and secondary 82 linkage pairs extend. The seventh shelf unit 6g has a rear wall 62g having two slits for accommodating the secondary linkage pair 82.

The second 6b, third 6c, fourth 6d, fifth 6e and sixth 6f shelf units 6 are similar to each other in that their leaves 60 are divided into three sections. Clearances between the leave 60 sections accommodate the secondary linkage pair 82. Each rear wall 62 has two slits for accommodating the secondary linkage pair 82. The second 6b, third 6c, fourth 6d, fifth 6e and sixth 6f shelf units 6 each have two pairs of spaced side walls 61 between which the secondary linkage pair 82 extends. These side walls 61 also have linkage-mounting regions between which the primary linkage pairs 81 extend. These linkage-mounting regions extend rearwardly of the rear wall 62.

The second 6b, third 6c, fourth 6d, fifth 6e and sixth 6f shelf units 6 differ from the others in that they have a secondary shelf 7b-f located beneath the main leave 60. The secondary shelf 7 is dimensioned so as to be hidden beneath the table top 110 formed by the main leaves 60 of the shelf units 6 when in the table configuration, and the secondary shelf 7 is dimensioned so as to serve as an additional accessible shelf when in the shelf configuration. The first 6a and seventh 6g shelf units do not have a secondary shelf so that a person seated at a front or rear end of the table top 110 has adequate leg room beneath the table top 110.

Each secondary shelf 7 includes a substantially horizontally extending secondary leave 70b-70f and a pair of spaced apart secondary side walls 61 extending between the main leave 60 and the secondary leave 70. The rear wall 62 of the shelf unit 6b-6f extends to the secondary leave 70b-70f. Shelf units 6a ad 6g each have side walls 61a, 61g and a rear wall 62a, 62g but no leave.

The shelf units 6 and secondary shelves 7 are wooden panels or boards (in some embodiments laminated) fastened together with mechanical fasteners such as screws and optionally non-mechanical fasteners such as adhesive.

Each member of the primary linkage member pair 81 and each member of the secondary linkage member pair 82 is a straight elongate tubular member of rectangular cross-section. The tubular members 81, 82 are made of metal. These tubular members 81, 82 have openings through which pivot pins/fastening pins/connecting screws extend and further extend into or through the side walls 61 of each shelf unit 1. Some of these are labelled with the numeral 89. Each of members 81 and 82 is pinned between respective adjacent side walls 61 of shelf units 6a, 6b, 6c, 6d, 6e, 6f and 6g. In this way, the tubular members 81, 82 are pinned for pivotal movement relative to the shelf units 6. The primary and secondary linkage member pairs 81, 82 are able to pivot in unison and parallel with each other between (1) the shelf configuration whereby the primary and secondary linkage member pairs 81, 82 extend substantially vertically and the leaves 60 extend in spaced substantially horizontal parallel planes above one another, and (2) the table configuration whereby the primary and secondary linkage member pairs 81, 82 extend substantially horizontally and the leaves 60 extend next to one another in substantially the one and the same substantially horizontal place to form a table top 110.

The front table leg assembly 90 includes a pair of vertically extending legs 91, a foot 92 extending perpendicularly and forwardly from a lower region of each leg 91, and a cross piece 93 extending between the legs 91. Each leg 91, foot 92 and cross piece 93 is a straight elongate tubular member of rectangular cross-section. Each foot 92 has a pair of pinned wheels 94, enabling the table 105 when in the shelf configuration to be wheeled from one location to another. Each leg 91 is pinned to a respective primary linkage member 81 and further to the third shelf unit's rear wall 62c by way of screws 89.

The rear table leg assembly 96 includes a pair of vertically extending legs 97 and a cross piece 98 extending between the legs 97. Each leg 97 and cross piece 98 is a straight elongate tubular member of rectangular cross-section. Each leg 97 is pinned to a respective primary linkage member 81 and further to the sixth shelf unit's rear wall 62f by way of screws 89.

The convertible table 105 can also have a counterweight connected to the first shelf unit 6a for helping raise the shelf units 6 into the shelf configuration.

The actuators 99 are gas struts and help a person pivot in a controlled manner the shelf units 6 into the shelf configuration or out of the shelf configuration. That is, each actuator 99 can help offset the lift weight and also prevent the shelves 6 from pivoting downwardly too quickly. One end of each actuator 99 is pinned to a vertically extending leg 91. Another end of each actuator 99 is pinned to linkage member 81. In some embodiments (not shown), the actuator is an electric actuator.

In use, the convertible table and shelves 105 can be configured as a table shown in FIG. 10 or configured as shelves as shown in FIG. 11. In order to change from the table configuration to the shelf configuration, a person raises the rear end of the table top 110 so that the shelf units 6 swing into the shelf configuration shown in FIG. 11. When in the shelf configuration, the feet 92 of the front table leg assembly 90 extend beneath the shelf units 6. Moreover, the rear table leg assembly 96 extends in substantially the same vertical plane as the front table leg assembly 90—i.e. in a compact state. When in the shelf configuration, items or articles placed on the main leave 60 and secondary leave 70 can be accessed. When in the table configuration, items or articles in the secondary leave 70/additional shelf 7 are hidden beneath the table top 110.

The front 90 and rear 96 table leg assemblies are connected to the third 6c and seventh 6f shelf units 6 respectively such that there is leg/knee room for a person seated at the table top 110 adjacent those shelf units 6c, 6f. The rear wall 62 of each shelf unit 6 is also tapered/arched so as to provide additional room for that person's knees.

An advantage of the invention according to the second embodiment is that the table leg assemblies 90, 96 are recessed relative to the periphery of the table top 110, to provide legroom for a person seated at the table 105.

Another advantage of the invention according to the second embodiment is that the secondary shelf 7 can be used to hide items or articles when in the table configuration, but when in the shelf configuration those hidden articles or items can be accessed.

Another advantage of the present invention is that the table leg assemblies 90, 96 are not located midway between the front and rear ends of the table top 110. This means that the invention can accommodate further shelf units, if desired.

Yet another advantage of the invention according to the second embodiment is that in the shelf configuration it has a narrow footprint, which allows it to be placed/stored close against a wall.

The invention according to the second embodiment overcomes one or more other disadvantages referred to in the Background Section of this specification.

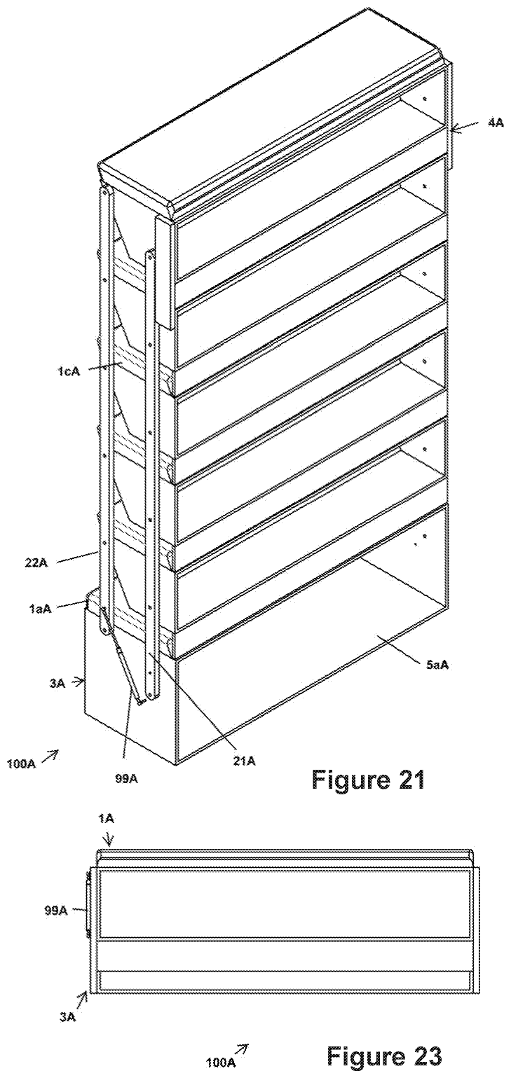

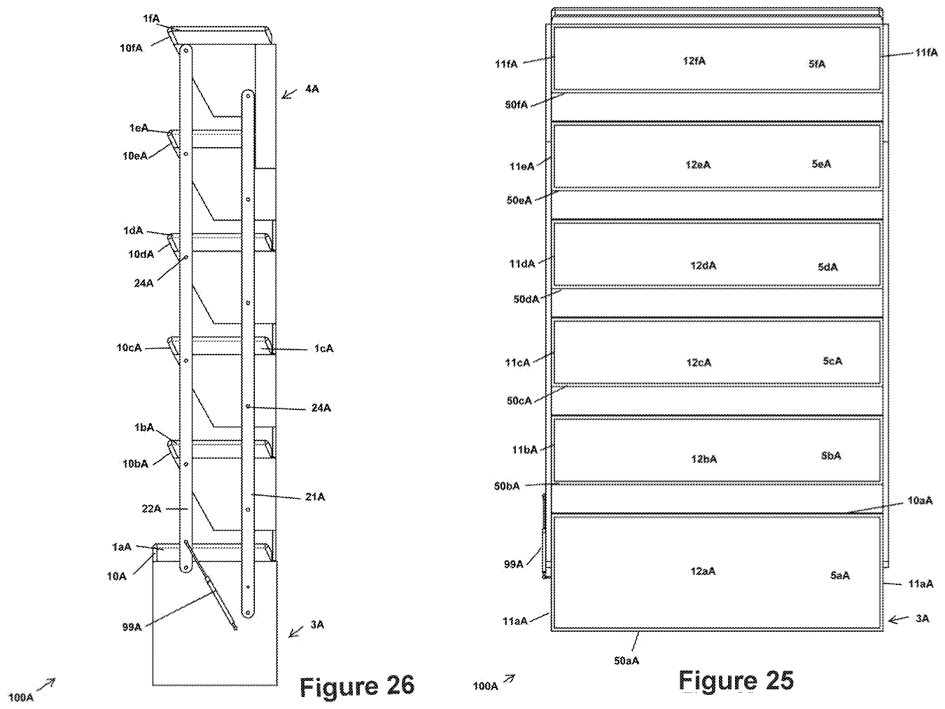

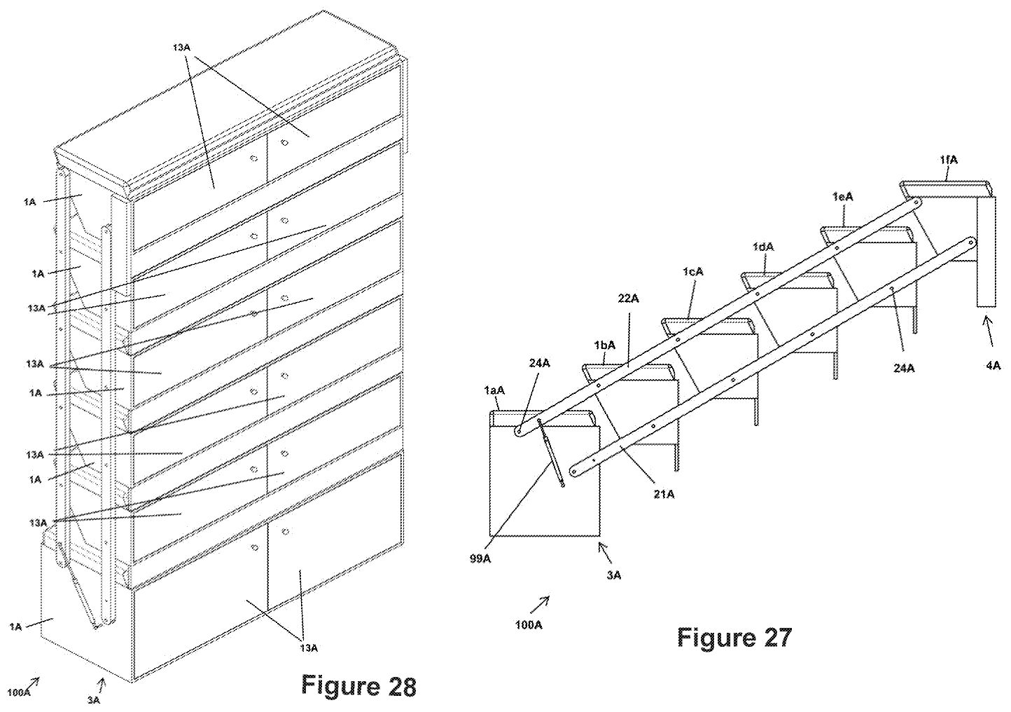

Referring now to FIGS. 20-27, there is shown a convertible bed/mattress base and shelves 100A that is configurable either as a bed/mattress base having a substantially horizontal surface 101A as seen in FIG. 20 or shelves as seen in FIG. 21.

The convertible bed/mattress base and shelves 100A includes first 1aA, second 1bA, third 1cA, fourth 1dA, fifth 1eA and sixth 1fA shelf units 1A, a linkage system comprising a primary linkage member pair 21A and a secondary linkage member pair 22A pivotally connected to each shelf unit 1A, a first surface support 3A, a second surface support in the form of a table leg assembly 4A connected to the sixth shelf unit 1fA, and an actuator 99A.

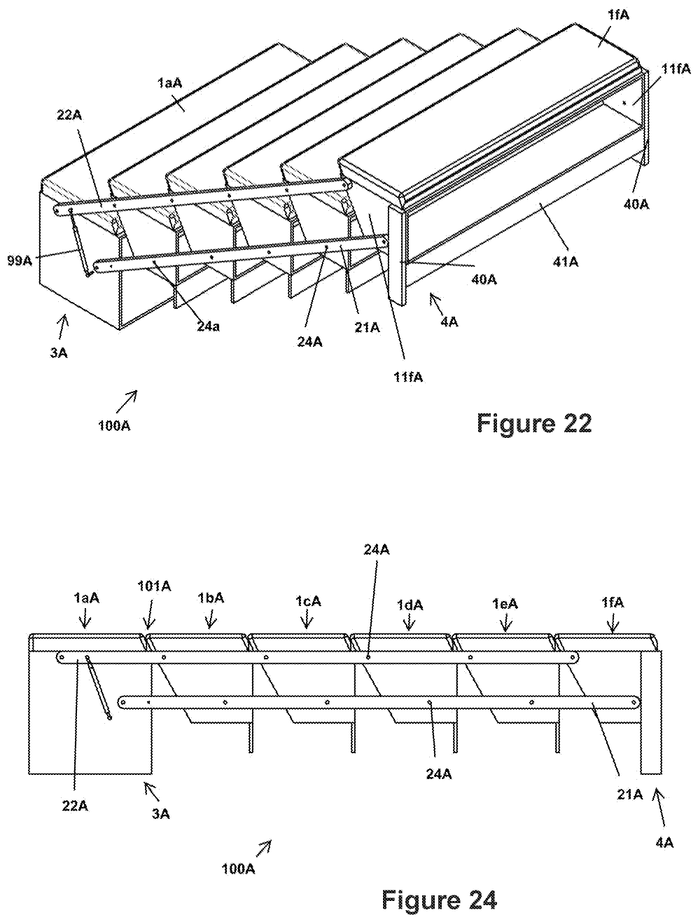

Each shelf unit 1A comprises a substantially horizontally extending leave 10aA-10fA and a leave support including a pair of spaced apart side walls 11aA-11fA extending downwardly from the leave 10aA-10fA and a rear wall 12aA-12fA extending between the leave 10aA-10fA and the side walls 11aA-11fA. The side walls 11aA-11fA extend parallel with the linkage members 21A, 22A and perpendicularly of the leaves 10aA-10fA. The rear walls 12aA-12fA extend vertically between the side walls 11aA-11fA. Each leave support includes a protruding drop-down lip that can hide gaps between the leaves when in the shelf configuration. (It is shown best in FIG. 22, though hard to see.)

Each leave 10aA-10fA may or may not be lined with a cushion liner or cushion, such as a layer of foam rubber, depending on whether the item of furniture is to serve as a base for a mattress or actual bed already having a thin mattress of sorts.

Shelf units 1aA, 1bA, 1cA, 1dA, 1eA and 1fA each have a secondary shelf 5aA-5fA located beneath the main leave 10aA-10fA. The secondary shelf 5aA-5fA is dimensioned so as to be substantially hidden beneath the bed base 101A formed by the main leaves 10aA-10fA of the shelf units 1A when in the bed base configuration, and the secondary shelf 5aA-5fA is dimensioned so as to serve as an additional accessible shelf when in the shelf configuration.

Each secondary shelf 5aA-5fA includes a substantially horizontally extending secondary leave 50aA-50fA that is secured to the side walls 11aA-11fA.

Each of the primary linkage member pair 21A and each of the secondary linkage member pair 22A is a bar of rectangular cross-section. The bars 21A, 22A are made of metal. These bars 21A, 22A have openings through which pivot pins/fastening pins 24A (only some of which are labelled) extend and fasten within a side wall 11aA-11fA of a shelf unit 1A. In this way, the bars 21A, 22A are pinned for pivotal movement relative to the shelf units 1A.

The primary 21A and secondary 22A linkage member pairs are able to pivot in unison and parallel with each other between (1) a shelf configuration (see FIGS. 21, 25 and 26) whereby the primary 21A and secondary 22A linkage member pairs extend substantially vertically and the leaves 10A (10aA-10fA), 50A (50aA-50fA) extend in spaced substantially horizontal parallel planes above one another, and (2) a bed base configuration (see FIGS. 20, 23 and 24) whereby the primary 21A and secondary 22A linkage member pairs extend substantially horizontally and the leaves 10A extend next to one another in substantially the one and the same substantially horizontal place to form a substantially flat support surface 101A (mattress/bed base).

The first surface support 3A and shelf unit 1aA are one and the same. A shelf unit 1aA does not pivot to a raised position.

The second table leg assembly 4A includes a pair of legs 40A extending vertically from the side walls 11fA of shelf unit 1fA, and a cross piece 41A extending between the legs 40A.

The actuator 99A is a gas strut and helps a person pivot in a controlled manner the shelf units 1A into the shelf configuration or out of the shelf configuration, as described previously. One end of the actuator 99A is pinned to side wall 11aA. Another end of the actuator 99A is pinned to linkage member 22A. In some embodiments (not shown), the actuator is an electric actuator.

In use, the convertible bed/mattress base and shelves 100A can be configured as a bed base shown in FIG. 20 or configured as shelves as shown in FIG. 21. In order to change from the base configuration to the shelf configuration, a person raises shelf unit 1fA so that the shelf units 1bA-1fA swing into the shelf configuration shown in FIG. 21. When in the shelf configuration, as seen in FIG. 22, articles or items placed in the secondary leaves 50A can be accessed. When in the base configuration, items in the secondary leave 50A/secondary shelf 5A are largely hidden from view beneath the bed base 101A.

Referring now to FIG. 28, there is shown a convertible bed/mattress base and shelves 100B that is substantially the same as the one described previously 100A, except that each shelf unit 1A has a pair of sliding or hinged panel doors 13A. This embodiment illustrates that each shelf unit 1A can be in the form of a cabinet or other type of closable compartment.

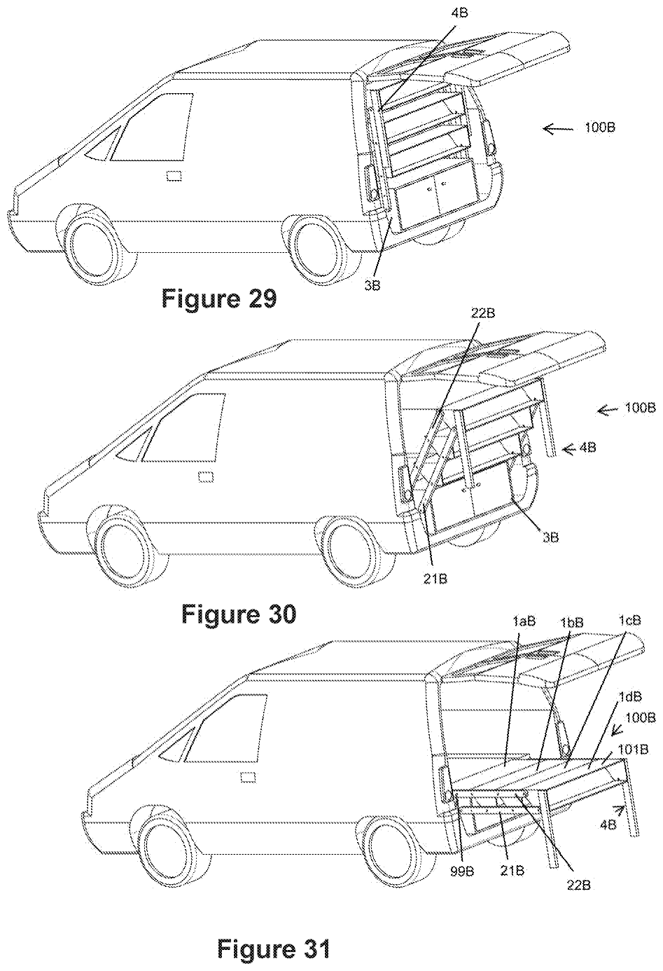

Referring now to FIGS. 29-31, there is shown a convertible workbench and shelves 100B mounted within a vehicle, and configurable either as a workbench having a substantially horizontal surface 101B as seen in FIG. 31 or shelves as seen in FIG. 29.

The convertible workbench and shelves 100B includes first 1aB, second 1bB, third 1cB and fourth 1dB shelf units 1B, a linkage system comprising a primary linkage member pair 21B, and a secondary linkage member pair 22B pivotally connected to each shelf unit 1B, a first surface support 3B, a second support surface in the form of a table leg assembly 4B connected to the fourth shelf unit 1dB, and a gas strut actuator 99B.

In almost all respects, the convertible bed/mattress base and shelves 100B is substantially the same as the one described previously 100A, except that it has fewer shelf units and each rear wall of the leave support extends at a sloping angle between the main and secondary leaves (ie. the main shelf and secondary shelf). The first surface support 3B and shelf unit 1aB are one and the same.

In use, the convertible workbench and shelves 100B can be configured as a workbench shown in FIG. 29 or configured as shelves as shown in FIG. 31. In order to change from the workbench configuration to the shelf configuration, a person raises shelf unit 1dB so that the shelf units 1dB-1dB swing into the shelf configuration shown in FIG. 29. When in the shelf configuration, as seen in FIG. 29, articles or items placed in the secondary leaves/shelves can be accessed. When in the workbench configuration, items in the secondary leaves/secondary shelves are hidden from view beneath the workbench 101B.

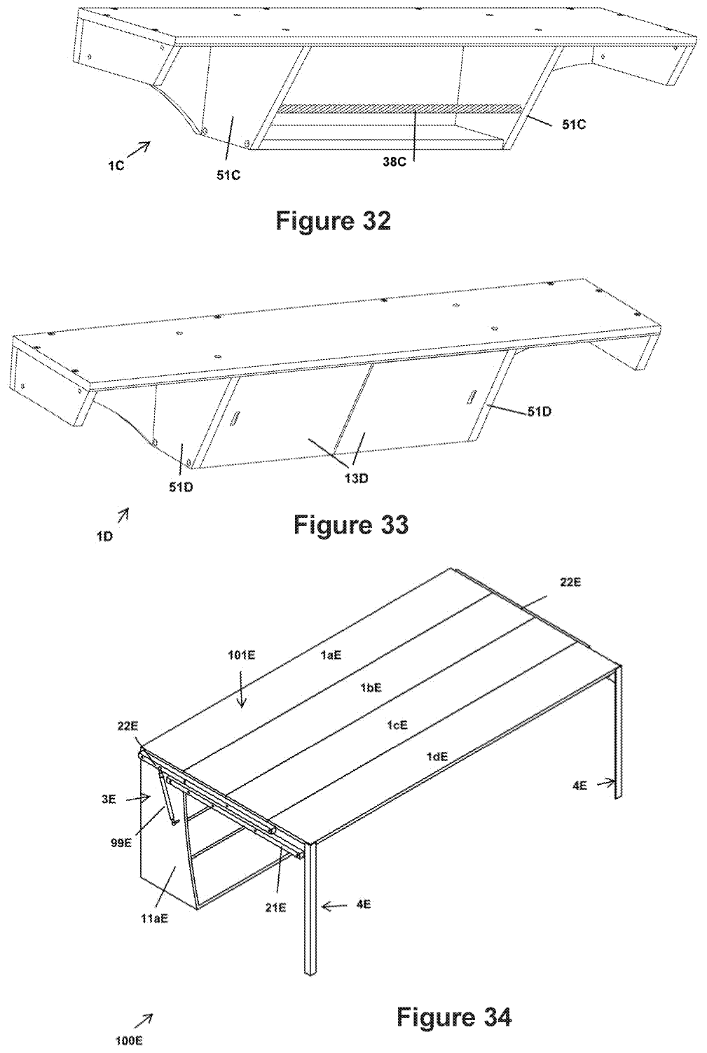

Referring now to FIG. 32, there is shown a shelf unit 1C according to another embodiment of the present invention. The shelf unit 1C is similar to shelf unit 1A except that it further includes a hanging rail or rod, or rope, wire or elastic retainer 38C extending between the side walls 51C.

Referring now to FIG. 33, there is shown a shelf unit 1D according to another embodiment of the present invention. The shelf unit 1D is similar to shelf unit 1A except that it further includes a pair of door panels 13D hinged to the side walls 51D. This embodiment illustrates that each shelf unit 1D (ie. secondary shelf) can be in the form of a cabinet or closable compartment.

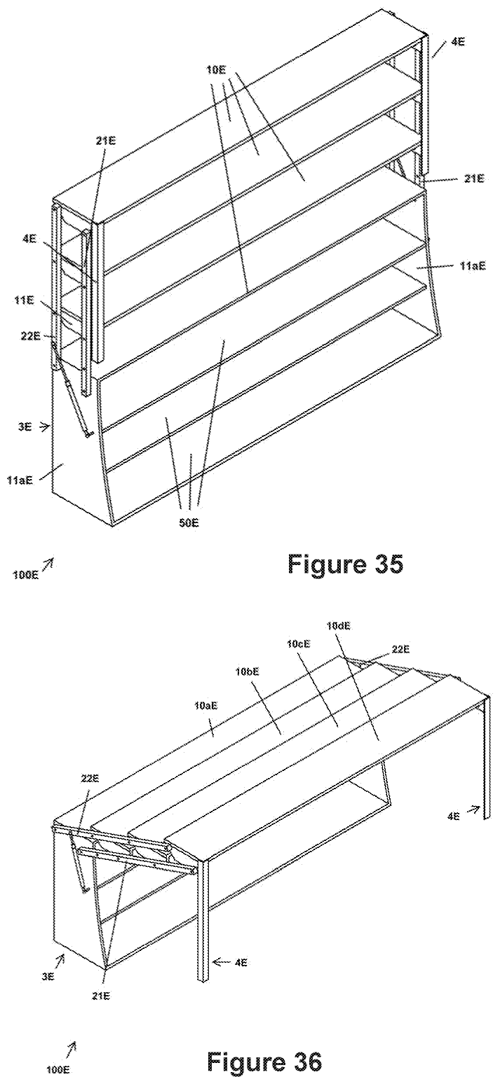

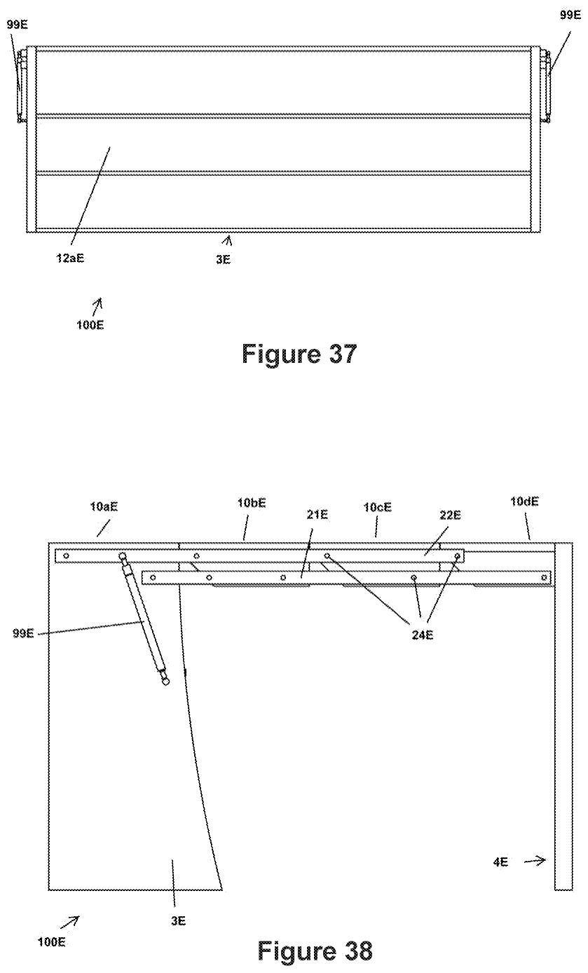

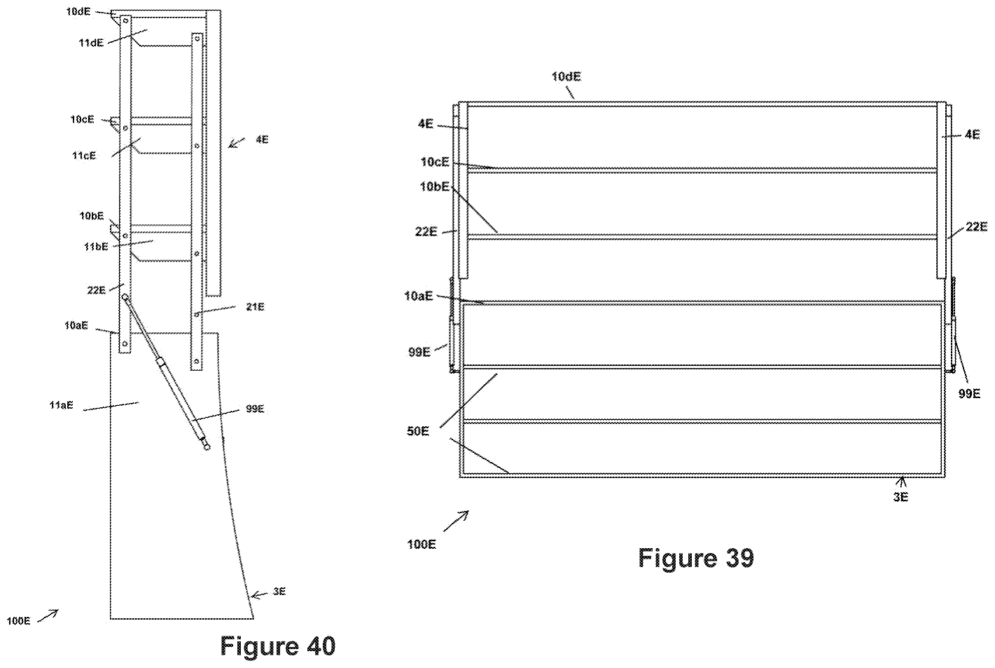

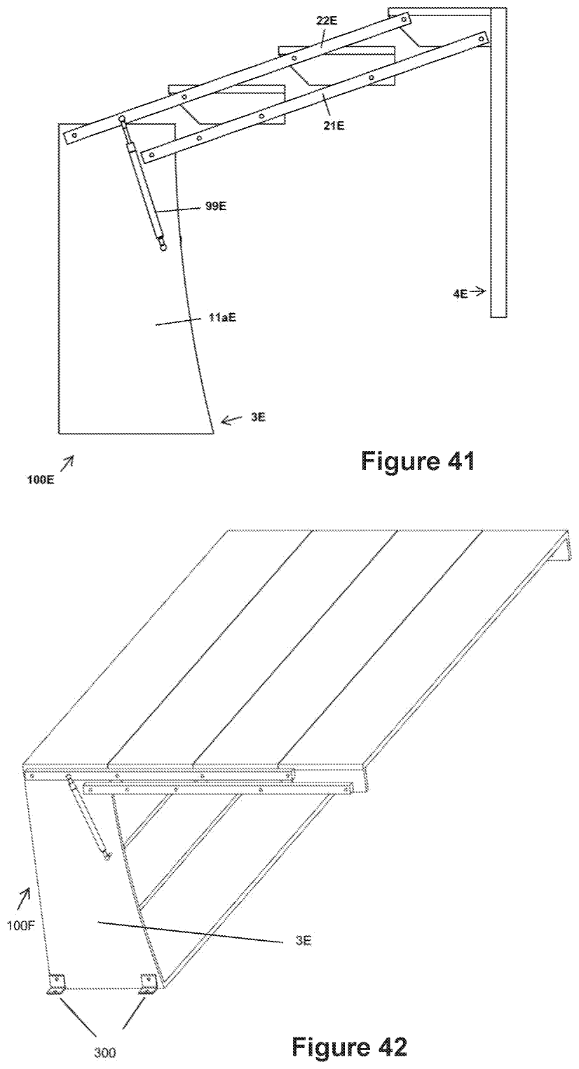

Referring now to FIGS. 34-41, there is shown a convertible desk and shelves 100E that is configurable either as a desk having a substantially horizontal surface 101E as seen in FIG. 34 or shelves as seen in FIG. 35.

The convertible desk and shelves 100E includes first 1aE, second 1bE, third 1cE and fourth 1dE shelf units 1E, a linkage system comprising a primary linkage member pair 21E and a secondary linkage member pair 22E pivotally connected to each shelf unit 1E, a first surface support 3E, a second surface support in the form of a table leg assembly 4E connected to the sixth shelf unit 1fA, and a pair of actuators 99E.

Each shelf unit 1E comprises a substantially horizontally extending leave 10aE-10dE and a leave support including a pair of spaced apart side walls 11aE-11dE extending downwardly from the leave 10aE-10dE. The side walls 11aE-11dE extend parallel with the linkage members 21E, 22E and perpendicularly of the leaves 10E.

The first surface support 3E and shelf unit 1aE are one and the same and include a set of secondary leaves 50E that extend between the side walls 11aE.

Each of the primary linkage member pair 21E and each of the secondary linkage member pair 22E is a bar of rectangular cross-section. The bars 21E, 22E are made of metal. These bars 21E, 22E have openings through which pivot pins/fastening pins 24E (only some of which are labelled) extend and fasten within a side wall 11E of a shelf unit 1E. In this way, the bars 21E, 22E are pinned for pivotal movement relative to the shelf units 1E.

The primary 21E and secondary 22E linkage member pairs are able to pivot in unison and parallel with each other between (1) a shelf configuration (see FIG. 35) whereby the primary 21E and secondary 22E linkage member pairs extend substantially vertically and the leaves 10E extend in spaced substantially horizontal parallel planes above one another, and (2) a desk configuration (see FIG. 34) whereby the primary 21E and secondary 22E linkage member pairs extend substantially horizontally and the leaves 10E extend next to one another in substantially the one and the same substantially horizontal plane to form a substantially flat surface 101E (desk top).

As mentioned, the first surface support 3E and shelf unit 1aE are one and the same. The second table leg assembly 4E includes a pair of legs extending vertically from the side walls 11E of shelf unit 1dE.

The actuators 99E are gas struts. One end of each actuator 99E is pinned to a side wall 11aE. Another end of each actuator 99E is pinned to linkage member 22E. In some embodiments (not shown), the actuator is an electric actuator.

In use, the convertible desk and shelves 100E can be configured as a desk shown in FIG. 34 or configured as (additional) shelves as shown in FIG. 35. In order to change from the desk configuration to the shelf configuration, a person raises shelf unit 1dE so that the shelf units 1bE-1dE swing into the shelf configuration shown in FIG. 35. When in the shelf configuration, as seen in FIG. 35, articles or items placed on the secondary leaves 50E can be more easily accessed.

Referring now to FIG. 42, there is shown a convertible desk and shelves 100F according to another embodiment of the present invention. The convertible desk and shelves 100F is almost identical to convertible desk and shelves 100E except that the first surface support 3E has mounting fixtures/brackets 300 for mounting it to a ground surface or other fixture. In view of this, the second table leg assembly 4E is optional/obsolete.

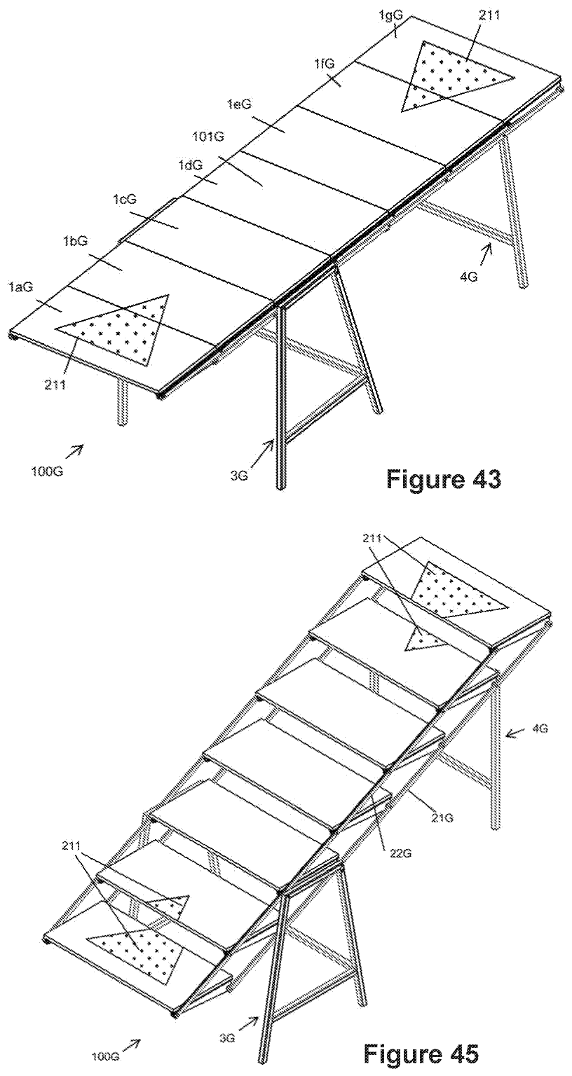

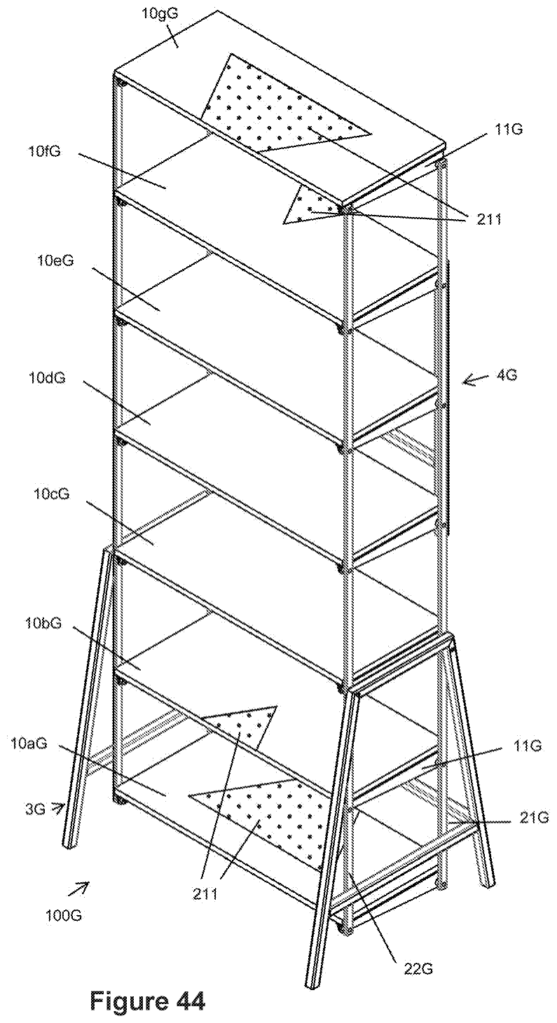

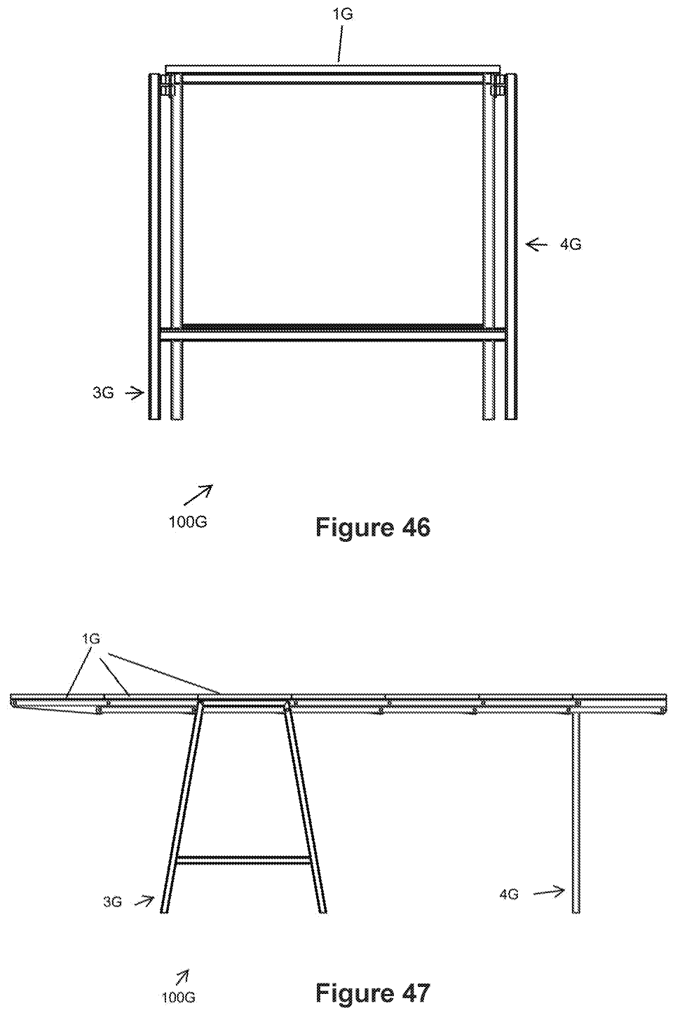

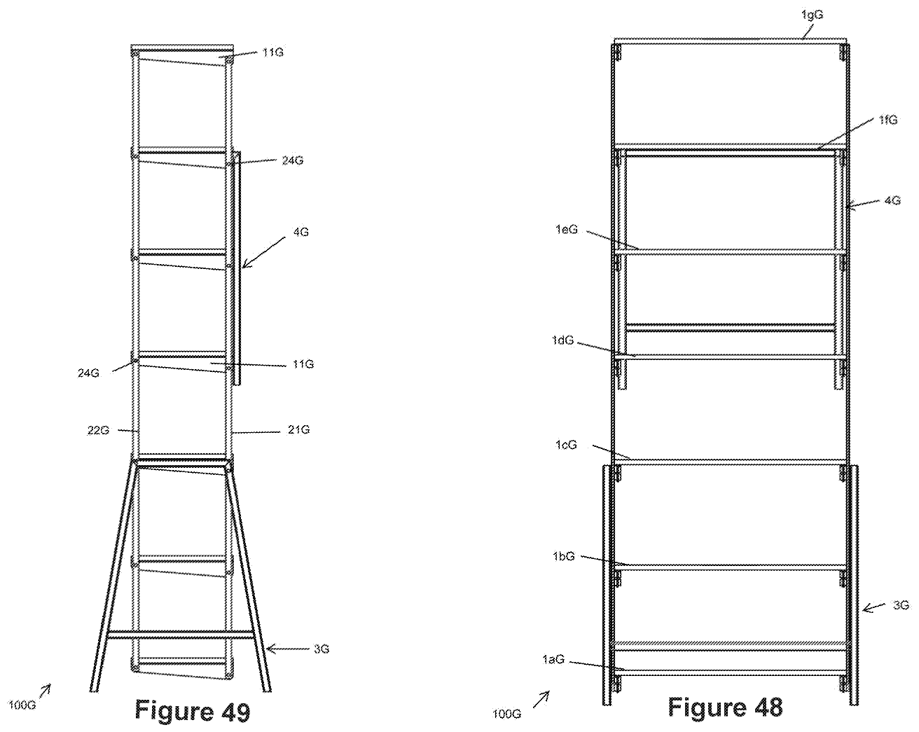

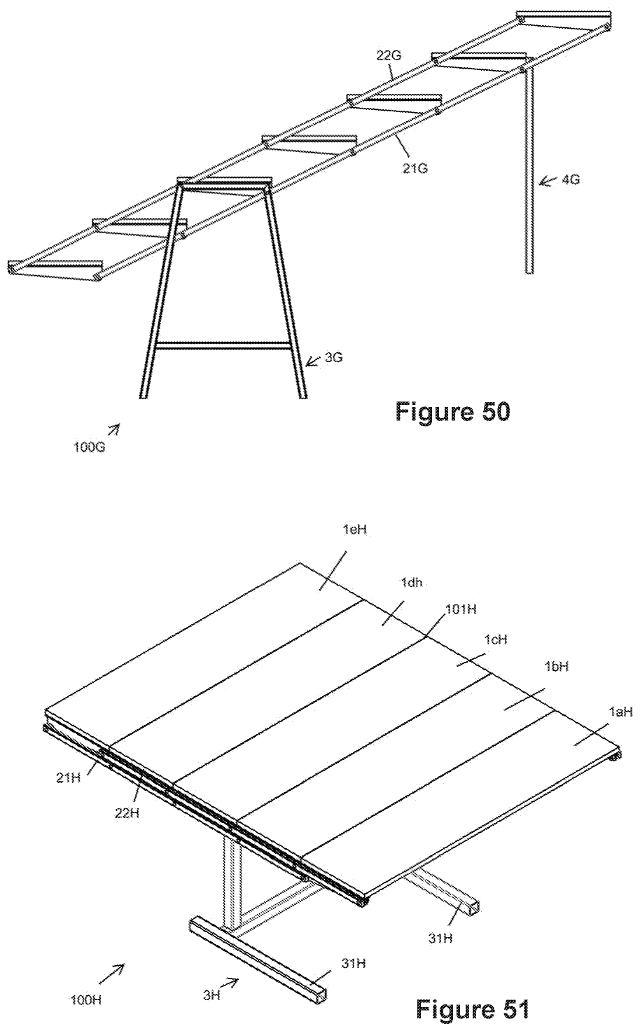

Referring now to FIGS. 43-50, there is shown a convertible gaming table (beer pong table) and shelves 100G that is configurable either as a beer pong table having a substantially horizontal surface 101G as seen in FIG. 43 or shelves as seen in FIG. 44. In many respects, furniture item 43 has features that are mostly the same as for other embodiments, and hence only a brief description will follow.

The convertible table and shelves 100G includes first 1aG, second 1bG, third 1cG, fourth 1dG, fifth 1eG, sixth 1fG and seventh 1gG shelf units 1G, a linkage system comprising a primary linkage member pair 21G and a secondary linkage member pair 22G pivotally connected to each shelf unit 1G, a first surface support in the form of a table leg assembly or stand 3G connected to the third shelf unit 1cA, and a second surface support in the form of a table leg assembly 4G connected to the sixth shelf unit 1fA.

Each shelf unit 1G comprises a substantially horizontally extending leave 10aG-10gG and a leave support including a pair of spaced apart side walls 11aG-11gG (11G) extending downwardly from the leave 10aG-10gG. The side walls 11aG-11gG extend parallel with the linkage members 21G, 22G and perpendicularly of the leaves 10G.

Each of the primary linkage member pair 21G and each of the secondary linkage member pair 22G is a bar of rectangular cross-section. The bars 21G, 22G are made of metal. These bars 21G, 22G have openings through which pivot pins/fastening pins 24G (only some of which are labelled) extend and fasten within a side wall 11G of a shelf unit 1G. In this way, the bars 21G, 22G are pinned for pivotal movement relative to the shelf units 1G.

The primary 21G and secondary 22G linkage member pairs are able to pivot in unison and parallel with each other between (1) a shelf configuration (see FIG. 44) whereby the primary 21G and secondary 22G linkage member pairs extend substantially vertically and the leaves 10G extend in spaced substantially horizontal parallel planes above one another, and (2) a gaming table configuration (see FIG. 43) whereby the primary 21G and secondary 22G linkage member pairs extend substantially horizontally and the leaves 10G extend next to one another in substantially the one and the same substantially horizontal place to form a substantially flat surface 101G (gaming table).

The first table leg assembly 3G includes splayed legs extending downwardly from the side walls 11G of shelf unit 1cG.

The second table leg assembly 4G includes a pair of legs extending vertically from the side walls 11G of shelf unit 1gG.

In use, the convertible gaming table and shelves 100G can be configured as a table shown in FIG. 43 or configured as shelves as shown in FIG. 44. In order to change from the table configuration to the shelf configuration, a person raises shelf unit 1gG so that the shelf units 1G swing into the shelf configuration shown in FIG. 44. Indicia 211 (ie. patterns, markings) appear on various leaves to produce a larger triangular pattern when configured as a beer pong table.

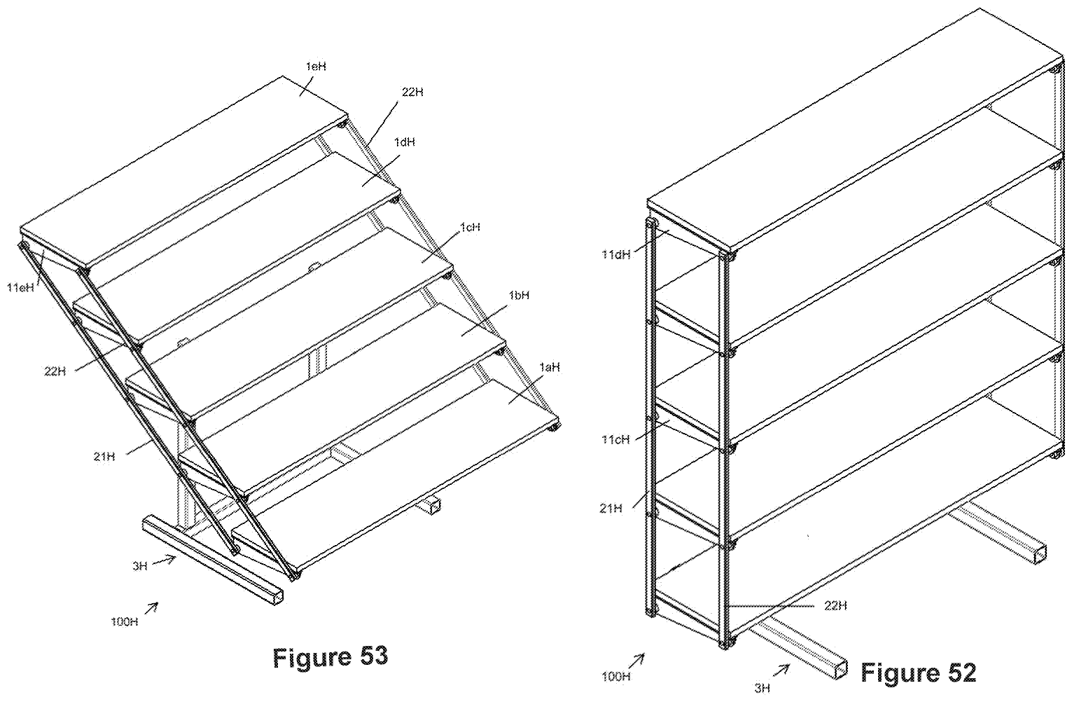

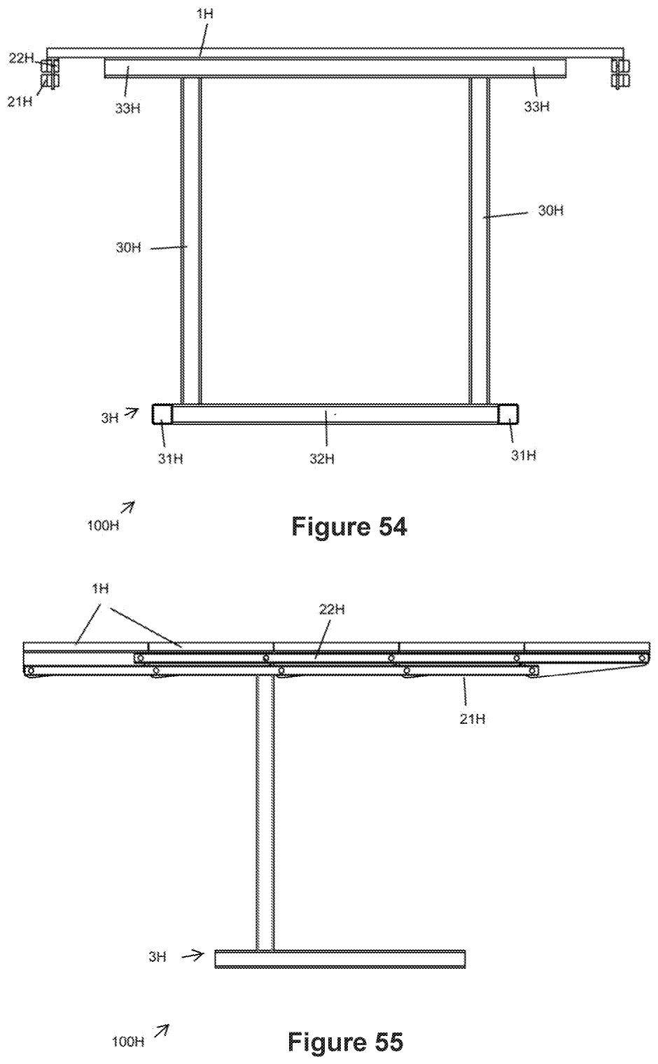

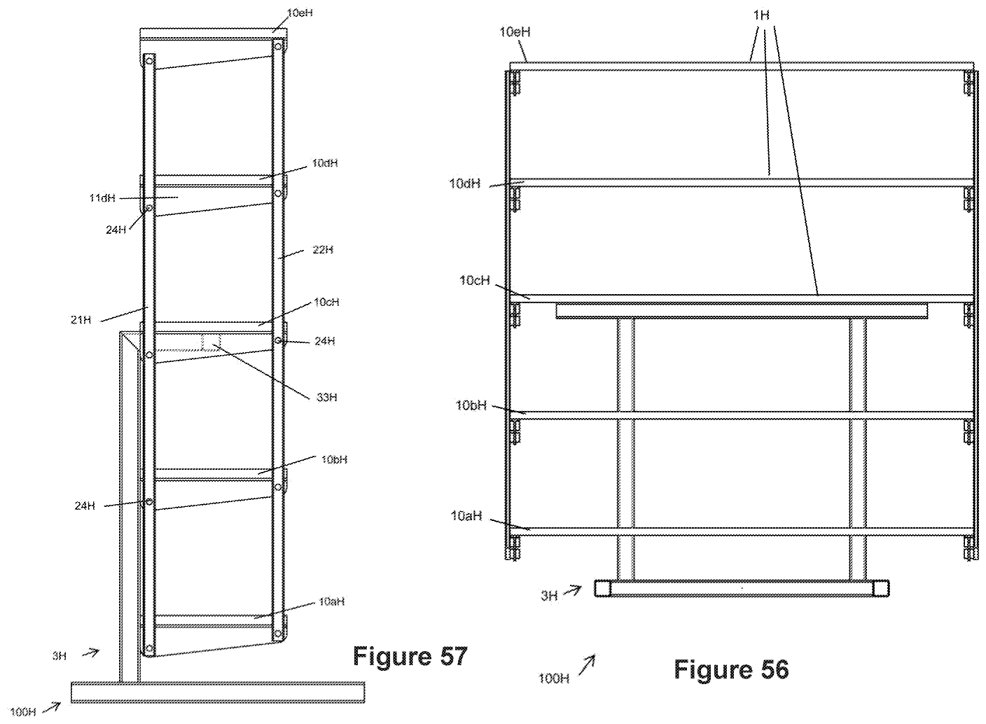

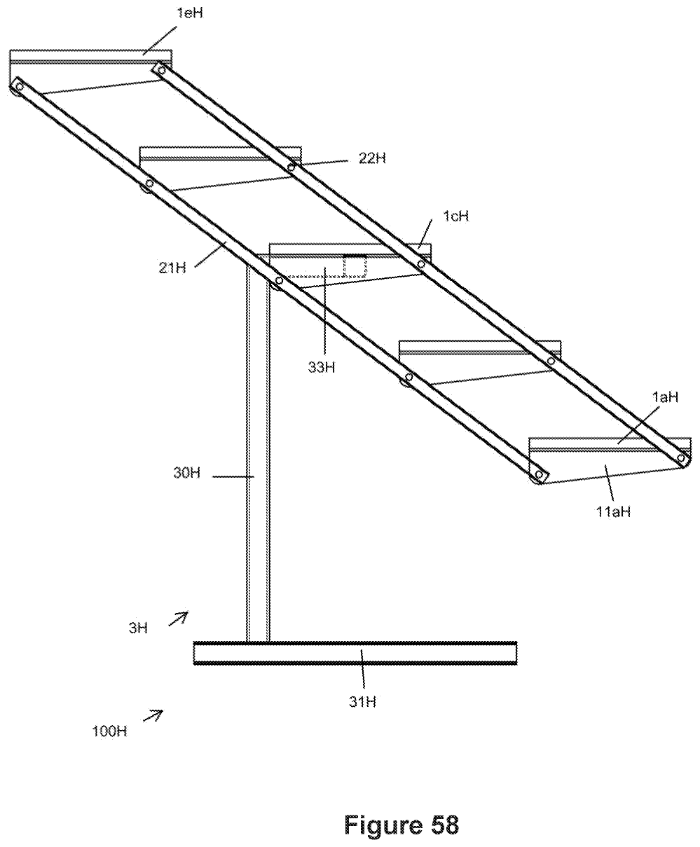

Referring now to FIGS. 51-58 is shown a convertible table and shelves 100H that is configurable either as a table having a substantially horizontal surface 101H as seen in FIG. 51 or shelves as seen in FIG. 52.

The convertible table and shelves 100H includes first 1aH, second 1bH, third 1cH, fourth 1dH and fifth 1eH shelf units 1H, a linkage system comprising a primary linkage member pair 21H and a secondary linkage member pair 22H pivotally connected to each shelf unit 1H, and a surface support in the form of a table leg assembly or stand 3H connected to the third shelf unit 1cG.

Each shelf unit 1H comprises a substantially horizontally extending leave 10aH-10eH and a leave support including a pair of spaced apart side walls 11aH-11eH extending downwardly from the leave 10aH-10eH. The side walls 11aH-11eH extend parallel with the linkage members 21H, 22H and perpendicularly of the leaves 10H.

Each of the primary linkage member pair 21H and each of the secondary linkage member pair 22H is a bar of rectangular cross-section. The bars 21H, 22H are made of metal. These bars 21H, 22H have openings through which pivot pins/fastening pins 24H (only some of which are labelled) extend and fasten within a side wall 11H of a shelf unit 1H. In this way, the bars 21H, 22H are pinned for pivotal movement relative to the shelf units 1H.

The primary 21H and secondary 22H linkage member pairs are able to pivot in unison and parallel with each other between (1) a shelf configuration (see FIG. 52) whereby the primary 21H and secondary 22H linkage member pairs extend substantially vertically and the leaves 10H extend in spaced substantially horizontal parallel planes above one another, and (2) a table configuration (see FIG. 51) whereby the primary 21H and secondary 22H linkage member pairs extend substantially horizontally and the leaves 10H extend next to one another in substantially the one and the same substantially horizontal place to form a substantially flat surface 101H (table top).

The table leg assembly 3H includes a pair of vertically extending legs 30H, a foot 31H extending perpendicularly and forwardly from a lower region of each leg 30H, a cross piece 32H extending between the legs 30H, and a lateral mount 33H extending laterally from an upper region of each leg 30H.

In use, the table and shelves 100H can be configured as a table shown in FIG. 51 or configured as shelves as shown in FIG. 52. In order to change from the table configuration to the shelf configuration, a person raises shelf unit 1eH so that the shelf units 1H swing into the shelf configuration shown in FIG. 52.

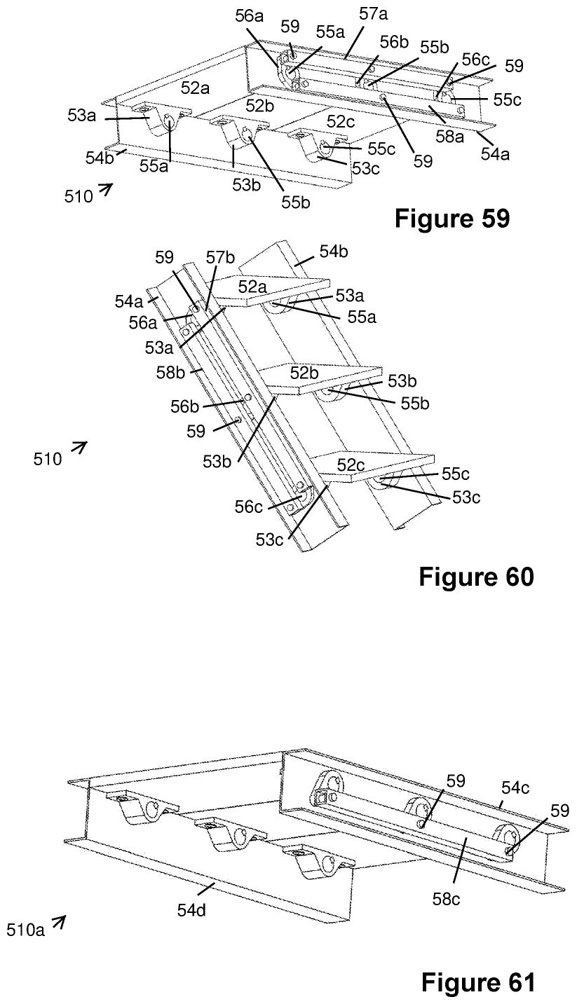

FIGS. 59 and 60 show part of a convertible item 510 utilising a rigid linkage system (drive system). The item 510 is shown as having three shelf units, each of which has a substantially horizontally extending leave 52a, 52b, 52c and a pair of leave supports 53a, 53b, 53c for supporting each leave 52. Each leave support 53 is in the form of a triangular casting having a shaft-receiving aperture. Each leave support 53 is connected to the leave 52 by way of screws. Although not shown, item 510 can include secondary leaves.

The convertible item 510 also has a linkage system connected to each leave support 53 such that the leaves 52 are able to pivot in unison and parallel with each other between (1) a shelf configuration whereby the leaves 52 extend in spaced substantially horizontal parallel planes above one another (see FIGS. 60), and (2) a substantially horizontal surface configuration whereby the leaves 52 are positioned next to one another to form a substantially horizontal surface (see FIG. 59).

The linkage system comprises a mounting frame comprising a pair of frame members 54a, 54b in the form of C-shaped channels, a plurality of shafts 55a, 55b, 55c, each having a working region 56a, 56b, 56c located within the channel and another end secured within the opening of the leave support 53, and a drive in the form of a respective pair of rigid linkage bar members 57a, 57b, 58a, 58b located within each frame member 54. Each rigid linkage bar member 57, 58 is connected to a flanged working end 56 of a shaft 55 by way of a pivot pin/fastening pin 59 (not all of which have been labelled).

FIG. 61 shows part of a convertible item 510a also utilising a drive in the form of a pair of rigid linkage bar members 58c (only one can be seen). The item 510a is very similar to the one shown previously 510 except that it has a single rigid linkage bar member 58c extending within each C-shaped channel 54c, 54d.

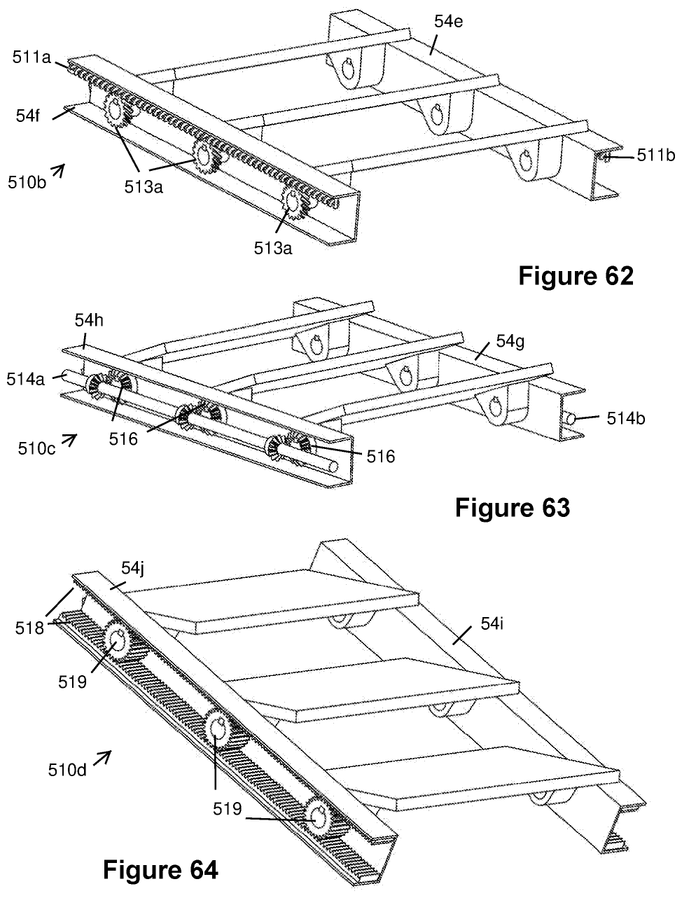

FIG. 62 shows part of a convertible item 510b utilising a drive in the form of a pair of worm gears 511a, 511b. The item 510b is very similar to the one shown previously 510 except that it has a worm gear 511 extending within each C-shaped channel 54e, 54f. Also, each working end of the shaft has a spur gear 513a which meshes with a worm gear 511. As the worm gear 511 turns in each channel 54, so do the shafts in unison.

The drive can further include an operable handle, crank or motor. Helical/worm gears may provide an advantage in that they create natural resistance to the shelf units pivoting.

FIG. 63 shows part of a convertible item 510c utilising a drive in the form of a pair of bevel gears 514a, 514b. The item 510c is very similar to the one shown previously 510 except that it has a bevel gear 514 extending within each C-shaped channel 54g, 54h. Also, each working end of the shaft has a spur gear 516 which meshes with a bevel gear 514. As the bevel gear 514 turns in each channel 54, so do the shafts in unison.

FIG. 64 shows part of a convertible item 510d utilising a drive in the form of a pair of racks 518. The item 510d is very similar to the one shown previously 510 except that it has a pair of racks 518 extending within each C-shaped channel 54i, 54j. Also, each working end of the shaft has a pinion 519 which meshes with and turns between the racks 518. As the shaft/pinion 519 turns, the racks 518 slide back and forth within the C-shaped channel 54.

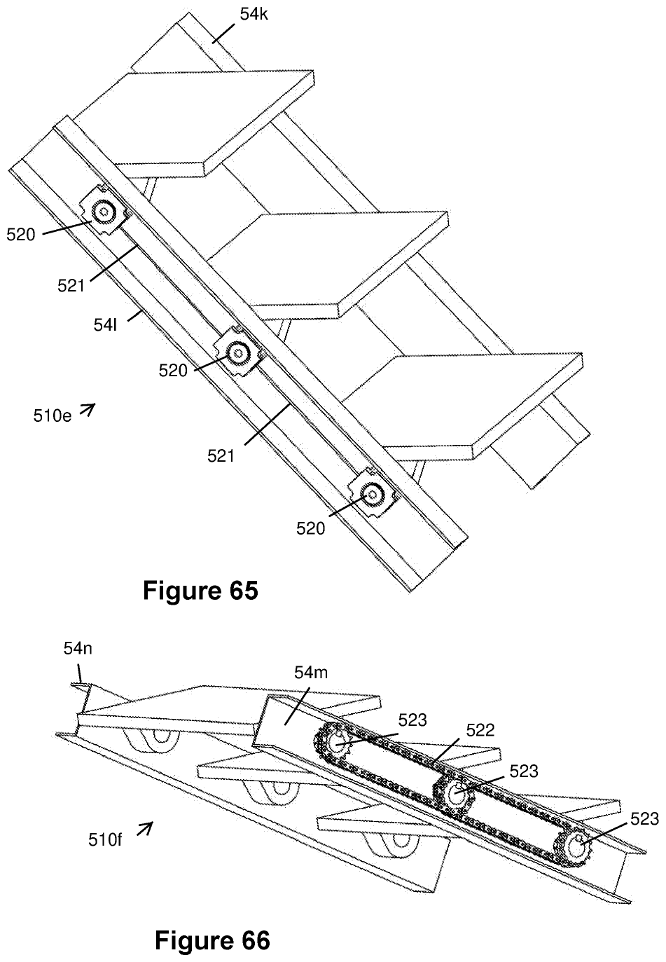

FIG. 65 shows part of a convertible item 510e utilising a drive in the form of motors 520 with encoders. The item 510e is very similar to the one shown previously 510 except that it has motors 520 located within each C-shaped channel 54k, 54l, each of which engages a working end of a shaft. Each of the motors 520 is electrically connected by wires 521 so that all motors 520 turn the shafts in a synchronised manner The encoders monitor and control the degree of rotation of the motors 520.

FIG. 66 shows part of a convertible item 510e utilising a drive in the form of two chain or belt drives 522. The item 510f is very similar to the one shown previously 510 except that it has chain or belt drives 522 located within each C-shaped channel 54m, 54n. Each working end of the shaft has a sprocket 523 that meshes with the chain or belt drive 522. As the chain or belt 522 moves in each channel, so do the shafts in unison.

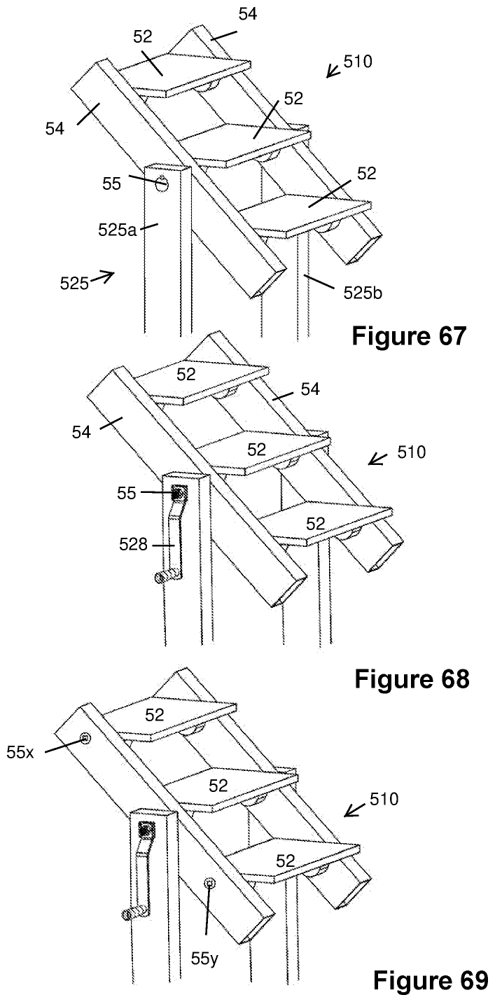

FIG. 67 shows how the item 510 of any of the earlier figures can include a surface support 525 comprising two upstanding legs 525a, 525b. In this embodiment, the frame members 54 are tubular members, enclosing the working ends of the shafts. Those legs 525a, 525b are pinned to two of the shafts 55 such that the frame members 54 can be freely raised and lowered between the shelf configuration and substantially horizontal surface configuration, but in doing so the leaves 52 are rotated so as to remain horizontal at all times. When in the substantially horizontal surface configuration, the leaves are locked together in that they bear against each other.

FIG. 68 shows how the drive can include a handle/crank 528 connected to a shaft 55 such that the leaves 52 can be rotated using the handle/crank 528. Meanwhile, the frame members 54 can rotate/pivot freely.

FIG. 69 shows essentially the same set up as FIG. 68, except that the top and bottom leaves 52 can have their inclination adjusted separately by way of a modified shaft 55x, 55y. This is in case they need to be adjusted horizontally, for perfect alignment with the other leaves.

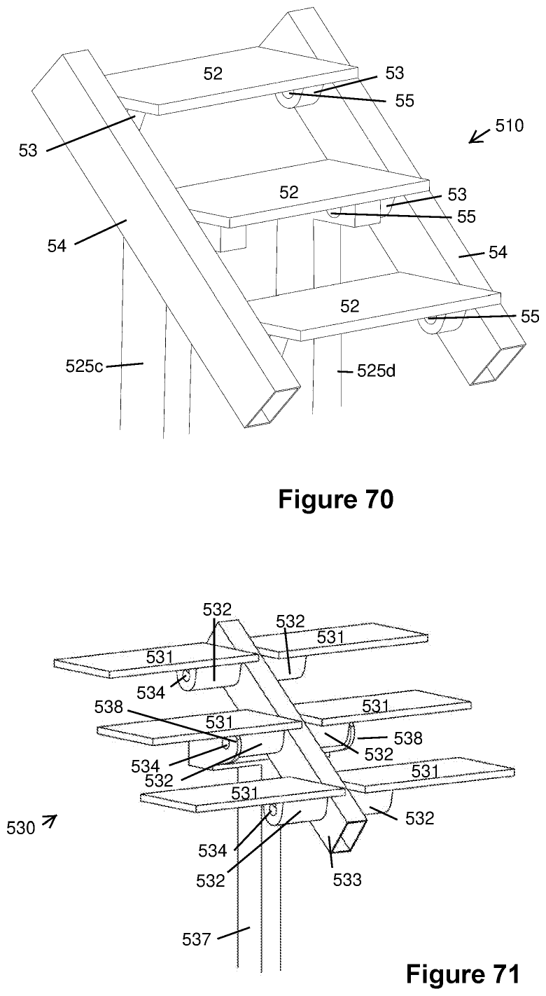

FIG. 70 shows how the item 510 of any of the earlier figures can include a surface support comprising two upstanding legs 525c, 525d. In this embodiment, the frame members 54 are tubular members, enclosing the working ends of the shafts 55. The legs 525c, 525d are pinned to two of the shafts 55/leave supports 53 between the frame members 54. Alternatively, the frame members 54 could be attached directly to a leave 52.

FIG. 71 shows another embodiment wherein a convertible item 530 comprises a plurality of shelf units, with each shelf unit comprising a substantially horizontally extending leave 531 and a leave support 532 for supporting the leave 531. The item 530 also comprises a linkage system comprising a tubular frame member 533 extending between pairs of leaves 531. The linkage system comprises a shaft 534 connected to each leave support 532 such that the leaves 531 are able to pivot in unison and parallel with each other between (1) a shelf configuration whereby the leaves extend in spaced substantially horizontal parallel planes above one another, and (2) a substantially horizontal surface configuration whereby the leaves 531 are positioned next to one another to form a substantially horizontal surface.

The item 530 also comprises a surface support 537 comprising an upstanding leg 537. In this embodiment, the leg 537 has a bracket 538 pinned to leave supports 532 using a shaft 534.

When a convertible item, such as a table, is long, it becomes very tall when in the shelf configuration. It can be dangerous and difficult to manoeuvre into the horizontal surface configuration especially when the shelves are loaded with heavy articles. Dampeners and actuators, including gas struts, springs or cams can be used to slow down the movement from the shelf configuration to the horizontal surface configuration, or to reduce the force of the shelves moving downwards to the horizontal surface configuration. However, this does not overcome the problem of the item potentially tipping over. Solutions to this problem include adding weight to the at least one support surface/base, or screwing the base/support surface down. A wider base/support surface is another option, but that would increase the footprint of the item, which is not always desirable or practical.

The problem associated with tipping can be overcome by using a surface support having a leg assembly pivotally connected to the linkage system and/or shelf unit whereby legs of the leg assembly extend apart from each other when pivoting to the substantially horizontal surface configuration, and the legs move closer together when pivoting to the shelf configuration. The leg assembly can be configured similarly to that of a collapsible stroller for an infant.

The problem associated with tipping can also be overcome by using an anti-tip support leg design. A unique feature is that shelf units can be placed against a wall and pulled down in one direction, and the support surface/base does not need to be affixed in place.

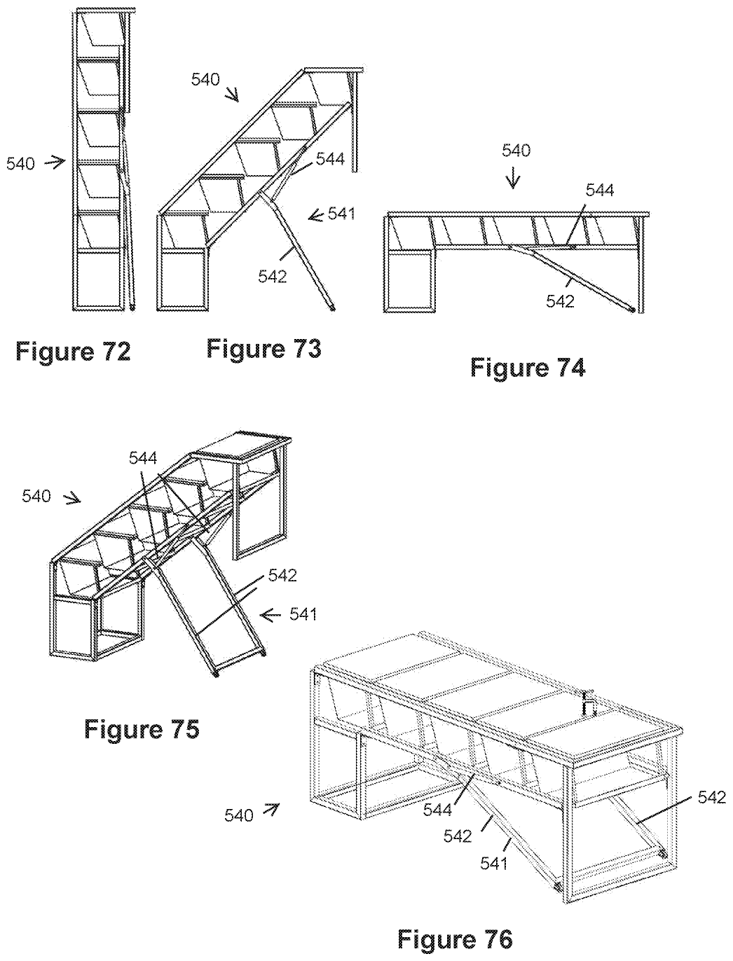

FIGS. 72 to 76 show a convertible item of furniture 540 that is very similar to furniture items shown in the figures preceding FIG. 59. The item 540 has a linkage system comprising linkage members previously described in those figures.

For item 540, the surface support includes a leg assembly 541 comprising legs 542 pivotally connected to the linkage system. A dampener pair, in the form of a pair of gas struts 544, extend from an upper region of the legs 542 to the linkage system. The legs 542 have ground-contacting wheels. The legs 542 fold against the shelf units when in the shelf configuration, as seen in FIG. 72. The legs 542 can extend away from the shelf units when the item 540 is moved towards the substantially horizontal surface configuration and slow the downward movement by way of the dampener pair 544, as seen in FIGS. 73-76.

The embodiment of FIG. 76 is a garage table featuring a large offset between the linkage members and table leaves. It also has a large gap between adjacent table leaves. This reduces any pinch points and also serves as a place to put clamps to hold down workpieces.

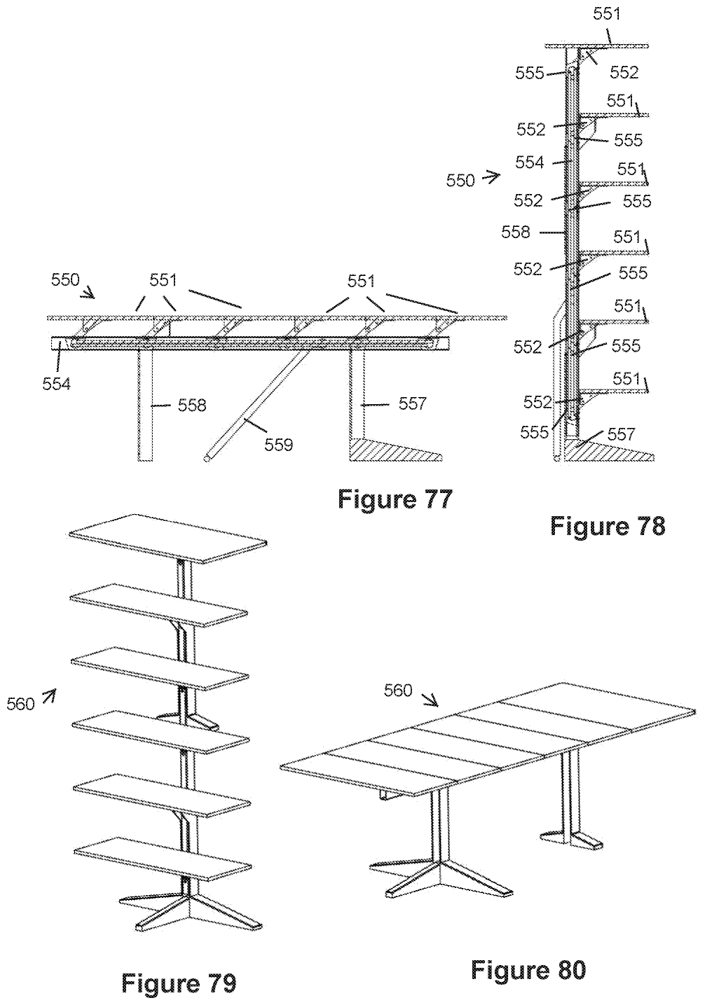

FIGS. 77 and 78 shows another embodiment wherein a convertible item 550 comprises a plurality of shelf units, with each shelf unit comprising a substantially horizontally extending leave 551 and a leave support 552 for supporting the leave 551. The item 550 also comprises a linkage system comprising a C-shaped frame member 554 extending adjacent the leaves 551. In other respects, the linkage system is like that shown in FIG. 59. The linkage system comprises a shaft 555 connected to each leave support 552 such that the leaves 551 are able to pivot in unison and parallel with each other between (1) a shelf configuration (FIG. 78) whereby the leaves 551 extend in spaced substantially horizontal parallel planes above one another, and (2) a substantially horizontal surface configuration (FIG. 77) whereby the leaves 551 are positioned next to one another to form a substantially horizontal surface.

The item 550 also comprises a surface support comprising a pair of legs 557, 558. Each leg 557, 558 is of a C-shaped cross section. Frame member 554 extends within the leg 557 when in the shelf configuration, as seen in FIG. 78. An upper region of leg 557 is pivotally connected to the leave support 552 by way of a shaft 555. Frame member 554 extends within the leg 558 when in the shelf configuration, as seen in FIG. 78. An upper region of leg 558 is pivotally connected to the leave support 552 by way of a shaft 555.

The surface support further comprises an anti-tip leg 559 that uses a rotary dampener. A top of the leg 559 is attached to the frame member 554 by way of a rotary dampener (not visible) that resists pivoting. When in the shelf configuration, as seen in FIG. 78, the anti-tip leg 559 extends adjacent leg 557. When in the substantially horizontal surface configuration, as seen in FIG. 77, legs 557 and 558 pivot downwardly from within the frame member 554, and the anti-tip leg 559 extends towards leg 558.

FIGS. 79 and 80 shows another embodiment wherein a convertible item 560 is very similar to item 550, except that it does not have the anti-tip leg 559.

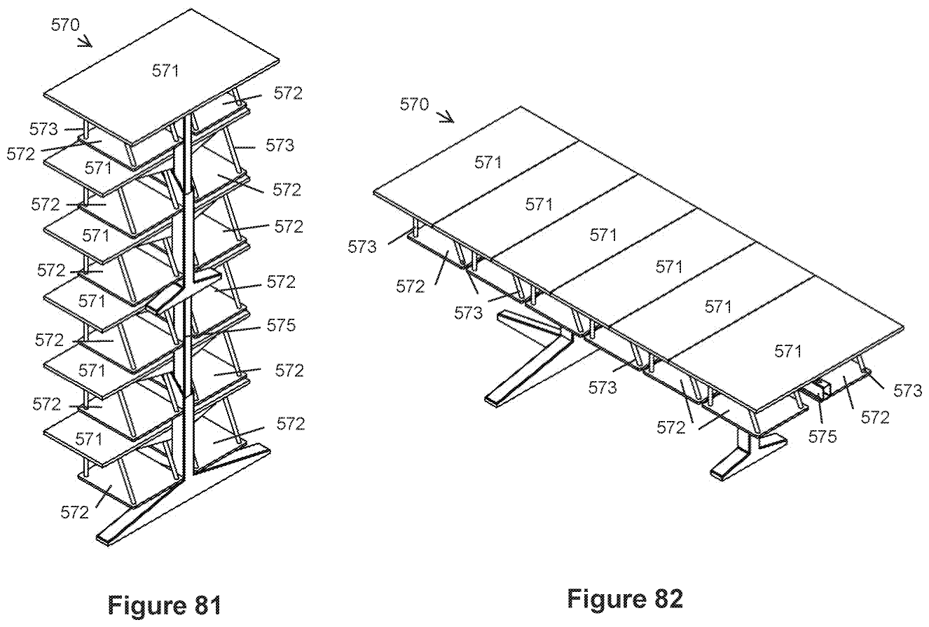

FIGS. 81 and 82 shows another embodiment wherein a convertible item 570 is very similar to item 560, except that it has both primary 571 and secondary leaves 572, as well as secondary leave supports 573 extending between the primary 571 and secondary leaves 572. The secondary leaves 572 extend either side of a frame member 575 of the linkage system. The leaves 571, 572 are able to pivot in unison and parallel with each other between (1) a shelf configuration (FIG. 81) whereby the leaves 571, 572 extend in spaced substantially horizontal parallel planes above one another, and (2) a substantially horizontal surface configuration (FIG. 82) whereby the leaves 571 are positioned next to one another to form a substantially horizontal surface.

Convertible items 550, 560 and 570 have leaves that are held at a greater distance from the rotating shafts. This gives clearance between the pivot point and the shaft, thereby reducing pinch points. Also, this means that the leave supports can be located midway beneath/centrally of the leaves, thereby further reducing pinch points. Also, only a single frame member is required, extending centrally of the leaves.

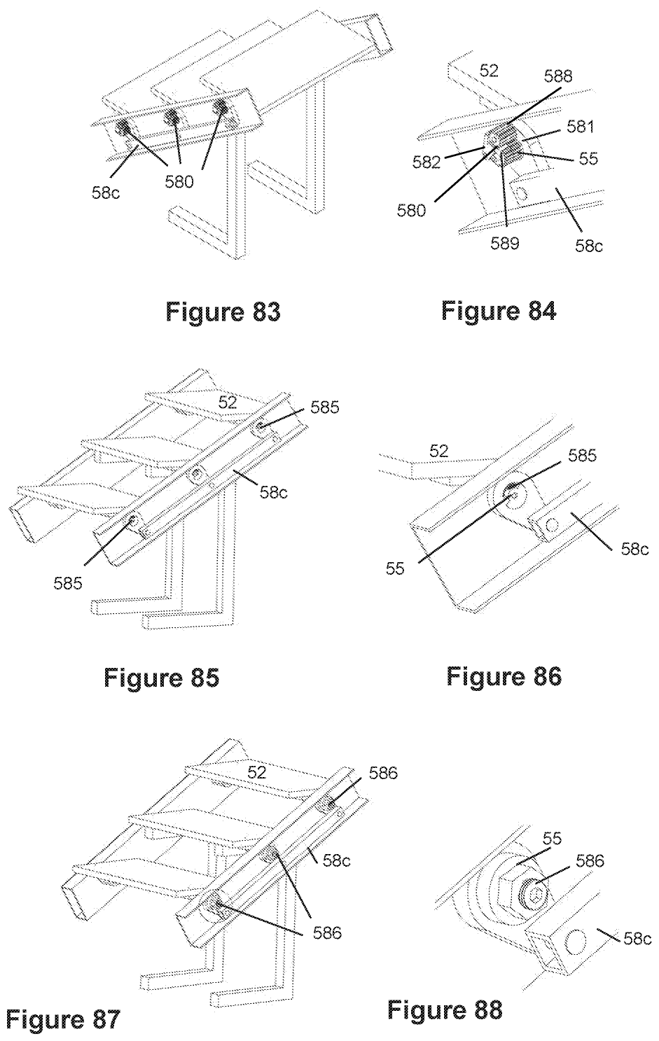

Referring now to FIGS. 83 to 88, these show that the angle at which a leave 52 extends can be adjusted independently of the other leaves. That is, the shaft 55 that is connected to the leave support can be further pivoted/rotated as required without engaging the drive. The drive 58c in this case is the same as that illustrated in FIG. 61.

FIGS. 83 and 84 show a locking gear mechanism which can lock or release a single leave's rotation from the drive. The table leave 52 is fastened to a gear or cogwheel 581 that can freely rotate independent of the drive. Gear 581 is meshed with gear 588. A pivoting latch 582 is sprung biased to lockingly engage the drive to gear 588 so that the drive and leave rotate together. Another independent gear 580 features a cam and missing teeth 589 so that it can initially rotate without engaging other gears. It also features an attachment point for a crank or handle. When rotated anticlockwise the cam opens the pivoting latch 582 while simultaneously meshing with gear 588. When the gear 580 is meshed with gear 588, the crank handle can then control the rotation of the leave, enabling the user to turn the leave without placing their hand near any potential pinch points. This is useful when the leave forms a tray or container that needs to be rotated and emptied.

FIGS. 85 and 86 show that a spring-loaded pivot 585 can be used. The springs are bias to hold the leaves 52 parallel to each other and strong enough that they would not be affected by normal rotation of the drive, but weak enough that a single leave could be forcefully rotated independently of the drive to empty its contents if need be.

FIGS. 87 and 88 show that a thread lock 586 can be used for fine adjustment of the leave angle.

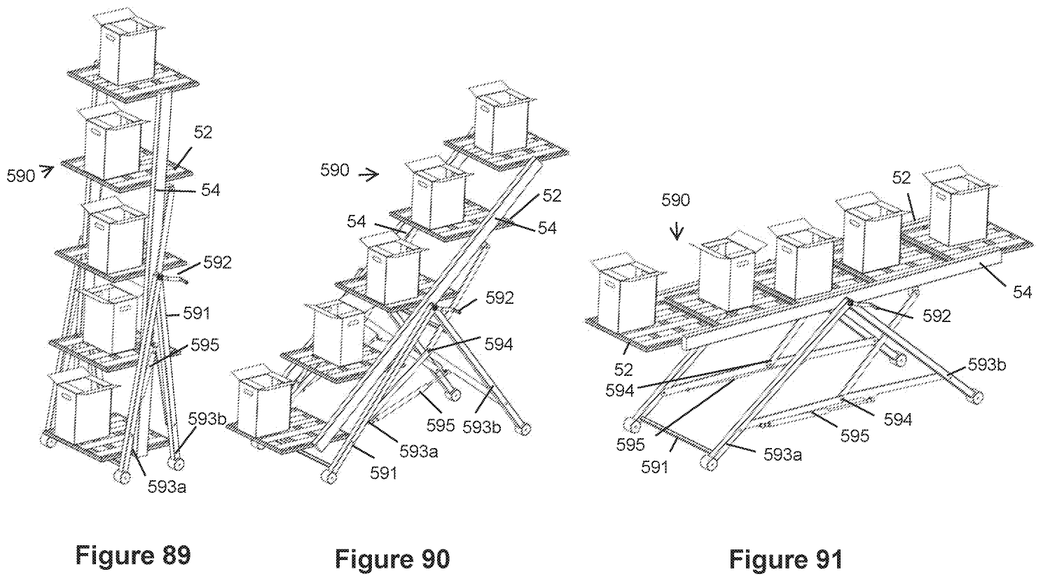

FIGS. 89 to 91 show a convertible item 590 having a linkage system (drive system) similar to that shown in FIG. 68. The drive includes a handle/crank 592 connected to a shaft of the drive system such that the leaves 52 are able to pivot in unison and parallel with each other between (1) a shelf configuration whereby the leaves 52 extend in spaced substantially horizontal parallel planes above one another (see FIG. 89), and (2) a substantially horizontal surface configuration whereby the leaves 52 are positioned next to one another to form a substantially horizontal surface (see FIG. 91).

The frame members 54 are tubular members, enclosing the working ends of the shafts. An anti-tip leg assembly 591 is pinned to two of the shafts of the drive system such that the frame members 54 can be raised and lowered between the shelf configuration and substantially horizontal surface configuration.

The item 590 is always balanced when moving between the different configurations. Legs 593a, 593b of the leg assembly 591 extend apart from each other when pivoting to the substantially horizontal surface configuration, and the legs 593a, 593b move closer together when pivoting to the shelf configuration. The leg assembly 591 utilises a hinge system 594 and gas struts 595 for achieving this.

The item 590 is for usage in storage garages, self storage and the like. It could be a replacement for commercial pallet racking in some situations, since there would be no forklift, ladders or lifting equipment needed to store boxes and pallets up to the ceiling, but then access them by hand when necessary. Use of gas struts 595 and handle/crank 592 would mean that the weight isn't a problem either.

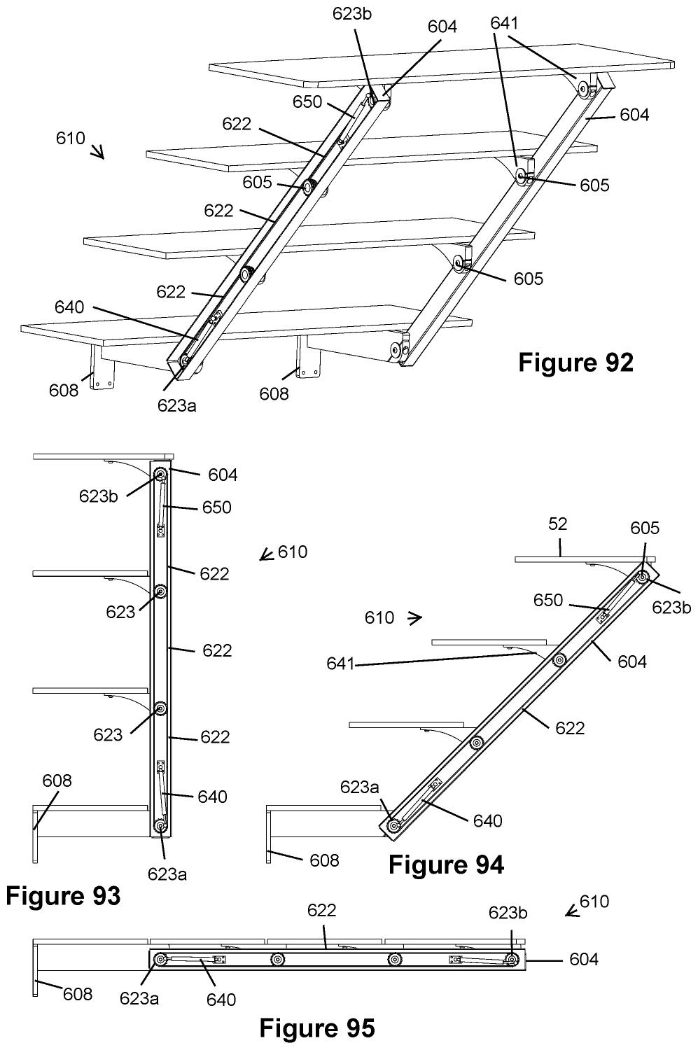

FIGS. 92-95 show part of a convertible item (shelf/table) 610 that is mountable to a wall by way of mounting brackets 608. The item 610 utilises a drive in the form of timing belt or chain drives 622. The item 610 is very similar to item 510f of FIG. 66, except that it has three timing belt or chain drives 622 located within each C-shaped frame member channel 604. Each working end of a shaft 605 has a sprocket or timing pulley 623 that meshes with a timing belt or chain drive 622. As the timing belt or chain 622 moves in each channel 604, so do the shafts 605 in unison.

The drive further comprises two pairs of actuators 640, 650. A first pair 640, each being a gas spring strut 640, extends between the frame member channel 604 and sprocket 623a and applies torque to the sprocket 623a, thereby creating a lift assist. Thus, less force is needed to transition the item 610 from a table (FIG. 95) to a set of shelves (FIG. 93). The gas spring strut 640 it is positioned in such a way that when the item 610 is transitioned into a table, the gas spring passes over centre and creates a small amount of torque in the opposite direction, thereby pushing the item 610 into a table configuration. The table has a mechanical stop (not labelled) that prevents it from rotating further than horizontal.

A second actuator pair 650, each being a gas damper 650, extends between the frame member channel 604 and sprocket 623b and applies torque to the sprocket 623b. Its function is to restrict the rotational speed of the sprocket 623b in either one direction or both directions. This results in the item 610 always transitioning slowly from a shelf to a table independently of how much weight is placed on the shelves/leaves 52, making it safer for the user and also avoiding a hard stop at the end of the rotation. In the case that it is restricted in one direction, the table may be transitioned to a shelf more rapidly.

The two actuator pairs 640, 650 could be replaced by one actuator pair that has both a dampening function and a spring function. Similarly, a rotary actuator, or a rotary spring could be used.

It is to be understood that there are other alternative suitable connection points for actuators, dampeners, cams, linkages or springs to affect the same function of assisting with the lifting and lowering of the item. For example, a strut, dampener, cam, linkage or spring can be mounted external to the frame member 604 and can be suitably connected to the wall mounting region 608 or any other part of the item that remains stationary during the transition from a substantially horizontal orientation to a vertical orientation and vice versa. Alternatively, a dampener, strut, cam, linkage or spring can be suitably connected from a leave support 641 to the frame member 604 such that during the transition from one configuration to the other the load is supported or assisted and the speed is governed or restricted providing a safer operation.

In the present specification and claims, the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. (canceled)

2. (canceled)

3. (canceled)

4. (canceled)

5. A convertible item comprising:
a plurality of shelf units, wherein each said shelf unit comprises a substantially horizontally extending leave and at least one leave support for supporting the leave;
a drive system connected to each said leave support such that the leaves remain substantially horizontal when the shelf units are moved between (1) a shelf configuration whereby the leaves extend in spaced substantially horizontal parallel planes above one another, and (2) a substantially horizontal surface configuration whereby the leaves are positioned next to one another to form a substantially horizontal surface; and
at least one surface support for supporting the shelf units and drive system.

6. The convertible item of claim 5, wherein the drive system comprises:
a respective shaft connected to each said leave support, wherein each said shaft comprises a leave support connecting end and a working region; and
at least one drive connected to the working regions of the shafts, such that the shafts are rotatable in unison.

7. The convertible item of claim 6, wherein the at least one drive is selected from the group consisting of:
at least one rigid linkage member connected to the working regions of the shafts by way of pivot pins or fastening pins;
two rigid linkage members connected to the working regions of the shafts by way of pivot pins or fastening pins;
at least one worm gear which engages the working regions of the shafts, and each said working region is in the form of a spur gear that meshes with the at least one worm gear;
at least one bevel gear which engages the working regions of the shafts, and each said working region is in the form of a spur gear that meshes with the at least one bevel gear;
at least one pair of racks that engage the working regions of the shafts, and each said working region is in the form of a pinion that meshes with and between the at least one pair of racks;
a plurality of motors, each of which engages a said working region of the shaft; and
at least one chain or belt drive that engages the working regions of the shafts, and each said working region is in the form of a sprocket that meshes with the at least one chain or belt drive.

8. The convertible item of claim 7, wherein the drive comprises two rigid linkage members connected to the working regions of the shafts by way of pivot pins or fastening pins.

9. The convertible item of claim 7, wherein the drive comprises at least one chain or belt drive that engages the working regions of the shafts, and each said working region is in the form of a sprocket that meshes with the at least one chain or belt drive.

10. The convertible item of claim 6, wherein the leave is discontinuous, being in separate panel sections, the drive system comprises a frame member extending between adjacent said panel sections, each said panel section comprises a said leave support, the drive extends within the frame member, the shaft extends through the frame member from one leave support to the other of the adjacent panel sections, and the working region of the shaft is located within the frame member.

11. The convertible item of claim 5, wherein the surface support is in the form of a leg assembly comprising legs pivotally connected to the drive system and/or at least one said shelf unit.

12. The convertible item of claim 5, wherein the convertible item comprises an anti-tip mechanism so that the item is always balanced when moving between the shelf configuration and the substantially horizontal surface configuration.

13. The convertible item of claim 12, wherein the anti-tip mechanism comprises the at least one surface support comprising a leg assembly pivotally connected to the drive system and/or at least one said shelf unit, whereby legs of the leg assembly extend apart from each other when pivoting to the substantially horizontal surface configuration, and the legs move closer together when pivoting to the shelf configuration.

14. The convertible item of claim 5, wherein the drive system comprises at least one mounting frame or frame member extending alongside the leave supports, and said shafts extend through a wall of the mounting frame or frame member such that the working regions and leave supports are located at opposite sides of the wall.

15. The convertible item of claim 14, wherein the at least one mounting frame or frame member is of hollow or tubular construction, and the working region of each shaft is located within the hollow interior.

16. The convertible item of claim 5, wherein the convertible item comprises one or more of the shelf units having a secondary shelf located beneath the substantially horizontally extending leave.

17. The convertible item of claim 16, wherein the secondary shelf is dimensioned so as to be hidden beneath the substantially horizontal surface formed by the leaves when in the substantially horizontal surface configuration, and the secondary shelf is dimensioned so as to serve as a secondary accessible shelf when in the shelf configuration.

18. The convertible item of claim 5, wherein the surface support is connected to a said shelf unit or said drive system such that there is adequate leg room for a person seated at the substantially horizontal surface.

19. The convertible item of claim 5, wherein the convertible item is in the form of a convertible table and shelves.
